(19) United States
(12) Patent Application Publication
(10) Pub. No.: US 2004/0145114 A1
(43) Pub. Date: Jul. 29, 2004

(54) Game timer with increased visibility

(76) Inventors: Dean Joseph Ippolito, White House Station, NJ (US); Geoffrey Michael Gelman, Stamford, CT (US)

Correspondence Address: Geoffrey Michael Gelman, 21 Belltown Road, Stamford, CT, 06905, US

(21) Appl. No.: 10/757,255

(22) Filed: Jan. 14, 2004

Related U.S. Application Data
(60) Provisional application No. 60/440,996, filed on Jan. 17, 2003.

(51) Int. Cl. A63F 9/00; G04F 8/00; G04F 10/00

(52) U.S. Cl. 273/148 R; 368/3; 368/96

(57) ABSTRACT

Various embodiments of the present invention include a chess clock with a first display facing in one direction and a second display facing in an opposite direction. Each of the first and second displays may display information about a single player of a chess game. Such information may include a time remaining in the game. A chess clock of the present invention may afford spectators and chess tournament directors a view of a player's time remaining from a wide range of vantage points. Various embodiments of the present invention include a chess clock with four displays, two displays corresponding to each of two players. The two displays corresponding to a given player may face in opposite directions. Various embodiments of the present invention include a chess clock suitable for simultaneous use in two separate chess games, or for use in a game of bughouse.

The present application claims the benefit of priority of U.S. Provisional Patent Application Serial No. 60/440,996, filed Jan. 17, 2003, entitled “Game Timer with Increased Visibility,” the entirety of which is incorporated by reference herein for all purposes.

### BACKGROUND

Chess is arguably the most popular game ever. It traces its origins to at least 1400 years in the past. It is played the world over. Chess is a game of complex strategies and near-infinite permutations. It has been called a sport, an art, even life itself. Political fortunes have centered on chess competitions. Chess is often regarded as the supreme test of human intellect.

The complexity of many chess games often leads players to spend lengthy amounts of time considering their moves. Many chess positions are so complicated that a person might spend hours, days, or even years trying to find the best move or the best strategy. Meanwhile, the player's opponent might be forced to wait for his turn. Sometimes, a player who has an inferior position will refuse to move at all, knowing that his opponent cannot win the game until the player has moved. The player may hope his opponent will simply give up in frustration.

As a consequence of the above and other considerations, the chess clock was invented. The first mechanical chess clock appeared in the late 1800's. One of the basic functions of a chess clock is to limit the amount of time a player can spend thinking about one or more moves. In one common scenario, a player must make a set number of moves within a designated period of time. For example, a player may be required to make 40 moves within two hours. If the player completes 40 moves within two hours then the player may receive, for example, an additional hour in which to complete an additional 20 moves. In a second common scenario, a player must complete all remaining moves of a game within a designated amount of time. For example, a player must make all the moves of a game within half an hour, regardless of whether the game lasts 10 or 100 moves. In a third common scenario, a player must complete a set number of moves, or all of his moves, within a designated amount of time. However, the amount of time is extended for each move the player completes. For example, a player may be required to complete all the moves of a game within 25 minutes. However, for each move the player makes, he receives an extra 5 seconds in which to complete all the moves of the game. The extra time a player receives after completing a move is called a time delay. Thus, if the player makes 10 moves within his first minute of time, the player will have lost a minute, but gained 50 seconds in which to complete all his moves. The player will therefore have 24 minutes and 50 seconds remaining. There are many other possible scenarios, and additionally there are many ways of combining the above scenarios. For example, a player may have two hours in which to complete his first 40 moves, and one additional hour to complete all the remaining moves of the game.

A player who does not complete a required number of moves in the allotted time will often lose the game, though the player may draw if his opponent does not have sufficient forces to ever deliver checkmate. As a result, the chess clock has become an integral part of a chess game. It is no longer strictly necessary for a player to deliver checkmate in order to win a game. Instead, a player might induce his opponent to spend so much time thinking that his opponent runs out of time. A player might also intentionally prolong the number of moves in a game so as to force his opponent to use more time in making all of the moves. For example, the player might initiate a number of attacks (checks) on his opponent's king which, while unnecessary from the vantage point of pure chess strategy, nevertheless increase the number of moves in the game. Often, a chess game will enter a stage where one player has run short of time. Perhaps, the player has only one minute remaining to complete the remaining moves of the game. The player is said to be in time pressure. As a result, the player may try to move quickly following his opponent's move, so as to use as little time as possible. When both players are short of time, a time scramble may result, with both players making moves in rapid succession.

When a player in a chess game is low on time, the game may become an exciting spectacle for onlookers. In particular, a time scramble may result in a rapidly changing position of the chess pieces, and may be punctuated by a number of player mistakes. Onlookers may wonder whether a player will be able to avoid mistakes with such limited time remaining. Onlookers may also wonder whether a player will be able to physically complete the required number of moves before running out of time. Frequently onlookers will crowd around a chess game to watch the time scramble. The onlookers often wish to see not only the chessboard, but also the chess clock. Since the chess clock is only visible from one direction, onlookers frequently crowd to one side of a chess game in progress. With onlookers all crowded to one side, there is less room for them to stand. They often create distractions for the players as they bump and jostle each other striving for a better view. In some cases, especially if a chess game is between two high-ranking players, the chess game may be roped off in order to keep onlookers at a distance from the chess game. Onlookers are then forced to stand behind the rope in order to watch the chess game. Frequently, however, the chess clock will not be facing towards the rope, and onlookers will not be able to see how much time each player has remaining.

In a chess tournament, a tournament director will often wish to view the displays on the chess clocks being used in the tournament. For example, at the start of a round, a tournament director may wish to verify that all chess clocks have been initialized with the same amount of time, e.g., with 1 hour per player. If a player within the tournament incorrectly initializes a chess clock with too much time, e.g., with 2 hours per player, then the player's game might last significantly longer than all of the other games, thereby delaying the start of the next round in the tournament. As a result, a tournament director may require that all chess clocks in a tournament be facing in the same direction, such as towards a center aisle where the tournament director will walk. The tournament director may also require, for aesthetic reasons, that all chess games being played at a given rectangular table have the black pieces on the same side of the table. With these two requirements satisfied, a tournament director, or an onlooker, might be able to look down the length of a rectangular table where, for example, five chess games are being played. Looking down the length of the table from one, of its ends, the tournament director would see the displays for all five chess clocks being used at the table. Furthermore, the tournament director would see the black pieces in each game on his right side, and the white pieces in each game on his left side (or vice versa, if so desired by the tournament director). In this scenario, a player of the black pieces would currently be forced to sit with a chess clock on his right side. However, players of the black pieces (especially if they are left-handed) sometimes demand that the chess clock be on their left side. Thus, it is currently difficult to simultaneously ensure that all chess clocks at a rectangular table face in the same direction, that all pieces of like color are aligned on one side of the table, and that all players of the black pieces have the chess clock on their preferred side

Tournament directors have many other reasons to view the displays on chess clocks. For example, when two players in a chess game have gotten into a time scramble, it may be important for a tournament director to judge whether a player has been able to deliver checkmate before running out of time. A player may deliver checkmate within small fractions of a second of running out of time, and so to determine which happened first, a tournament director must often have a clear view of both the chess clock's displays and of the game itself. Often, however, a tournament director may approach a chess game from the opposite direction from which a chess clock is facing. By the time the tournament director walks around to the other side of the chess clock, one player may have run out of time, and a dispute may have ensued. Moreover, a crowd of onlookers who can view the displays may block the tournament director from walking around to get a view of the chess clock's displays.

### BRIEF DESCRIPTION OF THE FIGURES

So that those skilled in the art may gain a better appreciation for the present invention, the present disclosure makes reference to the following figures:

FIG. 1 is a depiction of an exemplary chess clock of the prior art.

FIG. 1A is a depiction of an exemplary chess clock of the prior art, with part of the interior visible.

FIG. 2 is a depiction of an exemplary chess clock of the prior art.

FIG. 3 is a depiction of a chess clock according to one embodiment of the present invention.

FIG. 4 is a schematic depiction of a chess clock according one embodiment of the present invention.

FIG. 5 is a schematic depiction of a chess clock according one embodiment of the present invention.

FIG. 6 is a depiction of a game database for use in one embodiment of the present invention.

FIG. 7 is a depiction of a display database for use in one embodiment of the present invention.

FIG. 8 is a flow chart describing a method of operation for one embodiment of the present invention.

FIG. 9 is flow chart describing a method of using the chess clock of the present invention.

FIG. 10 is a depiction of an exemplary chess clock of the present invention showing exemplary dimensions for various features.

FIG. 11 is a depiction of a chess clock as it might be used in a tournament setting.

FIG. 12 is depiction of a chess clock as it is moved from one side of a chessboard to the other.

FIG. 13 is a depiction of a chess clock according to one embodiment of the present invention.

FIG. 14 is a depiction of a chess clock according to one embodiment of the present invention.

FIG. 15 is a depiction of a chess clock according to one embodiment of the present invention.

FIG. 16 is a depiction of a chess clock according to one embodiment of the present invention.

FIG. 17 is a depiction of a chess clock according to one embodiment of the present invention.

FIG. 18 is a depiction of a chess clock according to one embodiment of the present invention.

FIG. 19 is a depiction of a chess clock according to one embodiment of the present invention.

FIG. 20 is a depiction of a chess clock according to one embodiment of the present invention.

### DETAILED DESCRIPTION OF SOME EMBODIMENTS OF THE INVENTION

Varying embodiments of the present invention overcome the limitations of the prior art, and introduce new benefits, by providing a chess clock with a first display that faces in a first direction, and a second display that faces in a second direction. Additionally, varying embodiments of the present invention provide a chess clock with a mobile display that may, at different times, face in different directions. Further embodiments provide a chess clock with a display that can be viewed from multiple directions, and particularly, from a total number of directions encompassing more than two pi steradians of solid arc. The chess clock may allow a single display to be visible from multiple directions by incorporating mirrors to reflect light from the display in various directions, by incorporating a display with a transparent back panel, by incorporating a display whose surface is curved (e.g., convex), and by incorporating a display that is naturally visible over more than two pi steradians of solid arc (e.g., a fireworks display). These and other embodiments of the present invention will be more fully described below.

The chess clock of the present invention may therefore display information in more directions than do traditional chess clocks. For example, rather than incorporating displays only on the front face of a box-shaped chess clock, the present invention may incorporate displays on both the front and back faces, so that information is visible to players, spectators, and tournament directors on opposite sides of the chess clock. In particular, displays facing in different directions may display the same information, e.g., the amount of time remaining for a player. Therefore, if the present invention is in use, spectators of a chess game need not all crowd to one side of a chess clock. Accordingly, players and onlookers may enjoy greater comfort. Furthermore, with the present invention, tournament directors need not require that all chess clocks be situated on one particular side of a chessboard, since information displayed by a chess clock may be visible at a given location, no matter which side of the chessboard the chess clock is on.

Terms and Definitions

Following are definitions for several terms used in the present application. These definitions may be further expanded upon in the succeeding text.

As used herein, a “chess clock” is a mechanical, electrical, or electromechanical device for keeping track of the time used by one or more players during the play of a game. A chess clock is not limited to the game of chess, but may be used for any other applicable game, such as Scrabble, Othello, Backgammon, Monopoly, Bridge, and so on.

As used herein, a “clock” is a timer that keeps track of time for a single player. Typically, a chess clock consists of multiple clocks, one clock for each player. A clock may take a number of forms, such as a mechanical clock with a face and hands, or a location in a semiconductor memory storing a time that is periodically updated.

As used herein, a “clock button” is a button or other input mechanism that may be used to inactivate one or more clocks and/or to activate one or more clocks. Typically, there is one clock button that corresponds to each clock. A clock button is typically pressed by a player when he has made a move in a game. By pressing the clock button corresponding to his clock, the player may inactivate his clock and may activate the clock of his opponent. Thus, when it is the player's opponent's turn to move, the player is not losing time, and the player's opponent is losing time.

As used herein, a “display” is a medium through which information is conveyed from a chess clock to players, spectators or other parties. A display will typically show a time remaining for a player in a chess game. However, a display may show many other types of information, such as an amount of time remaining in a grace period, a player name, a number of moves completed, etc. A display may also be a clock, but need not be. For example, a mechanical clock with a circular face and moving hands would also be a display, since it directly shows time information to a player. However, an LCD (liquid crystal display) display of a time remaining is not the same thing as a clock, since the LCD display may be only a means of presentation for a time remaining that is stored in a memory internal to the chess clock. Therefore, it is possible that multiple displays may correspond to a single clock.

As used herein, an “input button” is a button on a chess clock that may be used to program the chess clock with game conventions, display configurations, and any other operational information. A chess clock may have any number of input buttons.

As used herein, the terms “housing,” “body,” “clock body,” “casing,” and “chassis” may be used interchangeably to refer to the main structural element of a chess clock. The housing may provide a rigid base to which displays, buttons, clocks, and other elements of a chess clock are attached. The housing may further enclose one or more other elements of the chess clock. For example, the housing may enclose a processor, memory, and battery of the chess clock. A typical housing may take the shape of a rectangular prism (a box shape). However, many other shapes are possible. A housing may be constructed of metal, wood, plastic, or other suitable material. Note that in some embodiments, a housing need not be rigid. Rather, a housing may have certain portions that are flexibly attached to one another and capable of motion relative to one another. In addition, a housing may consist of two or more entirely separate portions.

As used herein, the terms “time remaining” and “time” may be used interchangeably to refer to an amount of time that a player of a game is allowed in which to contemplate his activities in the game. If the player spends more than the “time” or “time remaining” in contemplation, then the player may suffer a penalty in the game, such penalty possibly including losing or drawing.

Figures in Detail

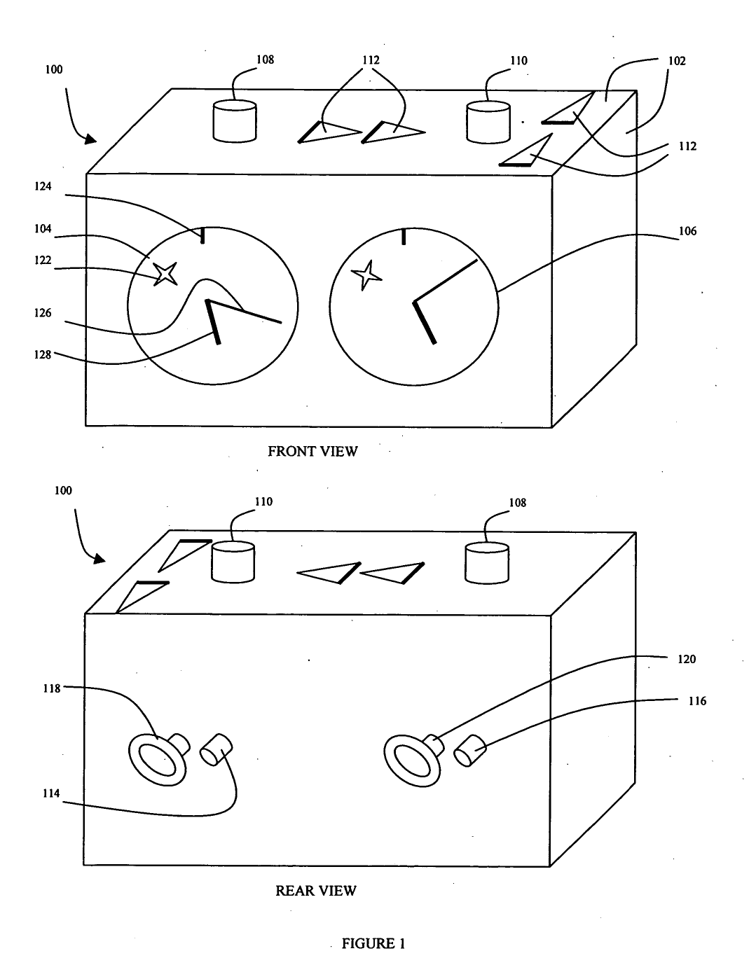

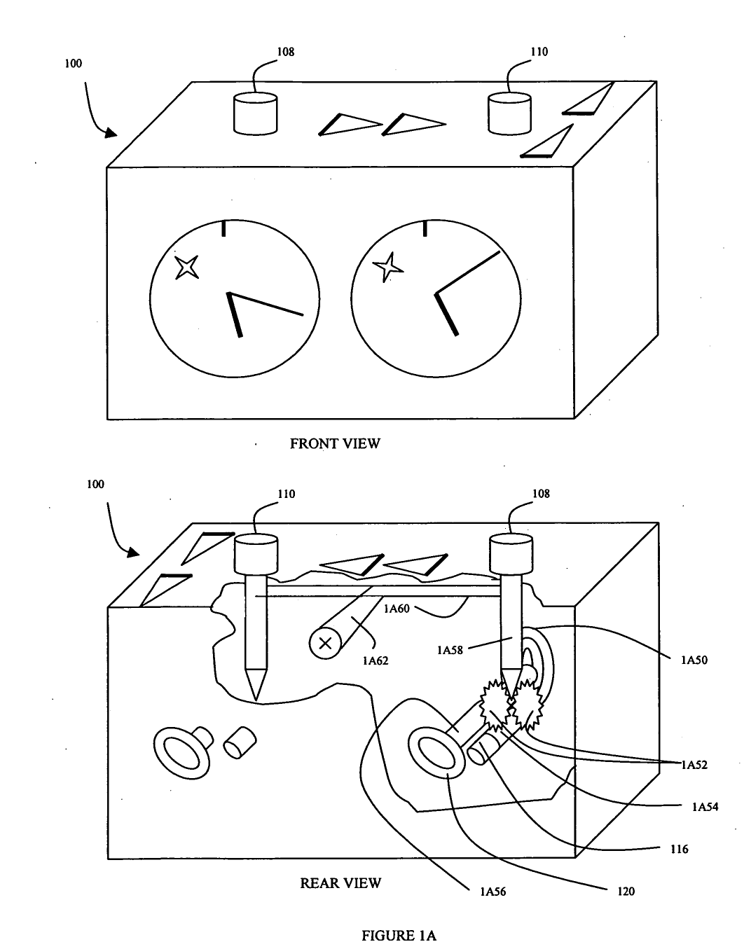

A more detailed reference is now made to the figures. FIG. 1 is an illustration of an exemplary chess clock 100 of the prior art. Both a front view (labeled “front view”) and a rear view (labeled “rear view”) are shown. FIG. 1A illustrates the same chess clock with part of the housing cut away from the rear view. The chess clock 100 is generally delineated by a housing 102, which in this case has the shape of box, though it may take many other shapes. On one face of the housing, hereinafter referred to as the front face, are inset two clocks 104 and 106. On another face of the housing, hereinafter referred to as the top face, are two clock buttons 108 and 110. In addition, the top face contains an ornamental pattern 112 consisting of two series of two triangles each. This and similar patterns will be used throughout the present disclosure for the sake of convenience only, as the patterns may more readily allow one skilled in the art to appreciate a reference orientation for the chess clocks illustrated herein. The patterns are not to be construed as being necessary for, or part of, the prior art or of the present invention. On another face of the housing, hereinafter referred to as the rear face, four knobs, 114, 116, 118, and 120; protrude from inside the housing.

The clocks 104 and 106 are ordinary analog clocks (such as wall clocks) with a few modifications. Clock 104 will now be described, although a similar description would also apply to clock 106. Clock 104 is powered by a spring 1A50 that is stored inside the housing 102. The spring is coupled to a gear assembly 1A52 that transfers the energy of the spring into the precise motion of the minute and hour hands of the clock in a manner that is wellknown in the art. In some clocks, second hands or even faster hands may be included as well. In addition, the same gear assembly 1A52 drives the motion of the “ticker” 122. One function of the ticker is to move in a perceptible manner when the clock is activated. A person might not be able to immediately ascertain whether the clock is activated just by watching the minute hand, as the minute hand may appear to move rather slowly. Another function of the ticker is sometimes to mark increments of time, such as seconds. For example, the ticker may rotate a perceptible amount precisely every second. An additional element not generally seen in ordinary clocks (e.g., watches or wall clocks) is a flag 124. When the chess clock 100 is in its normal upright position, the flag 124 is suspended at its upper edge by a small bar (not shown), which would appear perpendicular to the clock face. Thus, the flag 124 is free to swing from side to side (parallel to the surface of the clock face) about the bar. For the most part, due to gravity, the flag 124 hangs vertically, pointing straight downwards. However, at several minutes to the hour, the minute hand 126 of the clock approaches the flag 124 from the left and pushes the flag gradually into a horizontal position, with its tip pointing to 12:00. The flag 124 has just the right length, and just the right positioning, so that when the minute hand 126 reaches the hour, the minute hand has just moved beyond the length of the flag 124. With the minute hand 126 no longer supporting the flag 124 in its horizontal position, the flag drops back down into its vertical position. Thus, chess players do not have to judge exactly when the hour has been reached; instead they can tell by when the flag falls. Note that the hour hand 128 is generally too short to interfere with the flag.

Knob 116 is connected to a shaft 1A54 that is in turn coupled internally to the gear assembly 1A52 that drives the hands of the clock (i.e., the minute hand, hour hand, etc.). By turning knob 116, a person can change the position of the hands of the clock, thereby setting the time on the clock. If a chess game is to allow each player two hours in which to complete all moves of the game, then a player might use knob 116 to adjust the hands of the clock so that the clock reads 4:00. When the clock later reads 6:00, just after the flag 124 has fallen, then time is up.

Knob 120 is connected to a shaft 1A56 that is coupled internally to the spring 1A50 that powers the clock 104. Turning knob 120 in the proper direction will wind the spring 1A50. When the clock is activated, the spring 1A50 will gradually unwind, transferring its potential energy to the motion of the ticker 122 and the clock hands (126 and 128). Eventually, the spring 1A50 may exhaust its stored energy (as evidenced by the stillness of the ticker 122 when the clock 104 is supposedly activated), and a player may use knob 120 to wind the spring once again. Note that knob 120 has a wide handle, providing a person with a greater amount of leverage than is provided by knob 1116. The extra leverage may be necessary to overcome the resistance of the internal spring 1A50 to being wound.

Continuing reference is now made to FIG. 1A as the functioning of some of the internal machinery of chess clock 100 is described. Clock button 108 is used to inactivate clock 104, and may also be used to simultaneously activate the other clock 106. Clock button 108 generally has three positions, a raised position, a depressed position, and an intermediate position. Clock button 108 is connected internally to a vertically oriented rod 1A58. When clock button 108 is in its raised position, the lower tip of the rod 1A58 is near the gear assembly 1A52, but not touching. When clock button 108 is forced into its intermediate position e.g., by human pressure on the clock button, the tip of the rod 1A58 is forced correspondingly lower, where it interferes with the gear assembly 1A52, jamming the gear assembly 1A52. Similarly, when the clock button 108 is forced into its depressed position, the tip of the rod 1A58 also jams the gear assembly 1A52. Thus, when the clock button 108 is in its raised position, the clock 104 is activated and, provided there is adequate power in the spring 1A50, the ticker 122 and the clock hands (126 and 128) move. However, when the clock button 108 is in its intermediate or depressed position, the gear assembly 1A52 is jammed by the rod 1A58, and so the clock 104 is inactivated and the ticker 122 and the hands of the clock (126 and 128) do not move.

Clock buttons 108 and 110 are connected internally by a bar 1A60 which is oriented generally horizontally, but which can pivot several degrees in the vertical direction about another bar 1A62, which is located midway between the two clock buttons 108 and 110. The two clock buttons (108 and 110) therefore act as though they were on a seesaw. Forcing clock button 108 into its depressed position will force clock button 110, through the mechanism of bar 1A60, into its raised position. Similarly forcing clock button 110 into its depressed position will force clock button 108 into its raised position. Forcing either clock button into its intermediate position will also force the other clock button into its intermediate position.

It should be noted that the foregoing description is of an exemplary chess clock of the prior art, and that many variations in the construction and operation of the chess clock are possible. For example, the motion of the hands and the ticker may be powered by a battery rather than by a spring, and, accordingly, knobs 116 and 120 may not be present. Exemplary uses of chess clock 100 will now be described.

When chess clock 100 is not in use, clock buttons 108 and 110 are typically maintained in their intermediate positions. In this way, neither clock (104, 106) is activated and therefore neither spring is losing power. For battery powered chess clocks, maintaining clock buttons 108 and 110 in their intermediate positions saves battery power. At the beginning of a chess game, knobs 114 and 116 are turned so as to set the hands of the clocks to the appropriate time. For example, if each player is to complete all of his moves in one hour, then the hands of each clock are set to read 5:00, and it is understood that a player runs out of time when his clock reaches 6:00. Also, at the beginning of a chess game, knobs 118 and 120 may be wound in order to ensure that there is sufficient energy in the springs to last for the entire game.

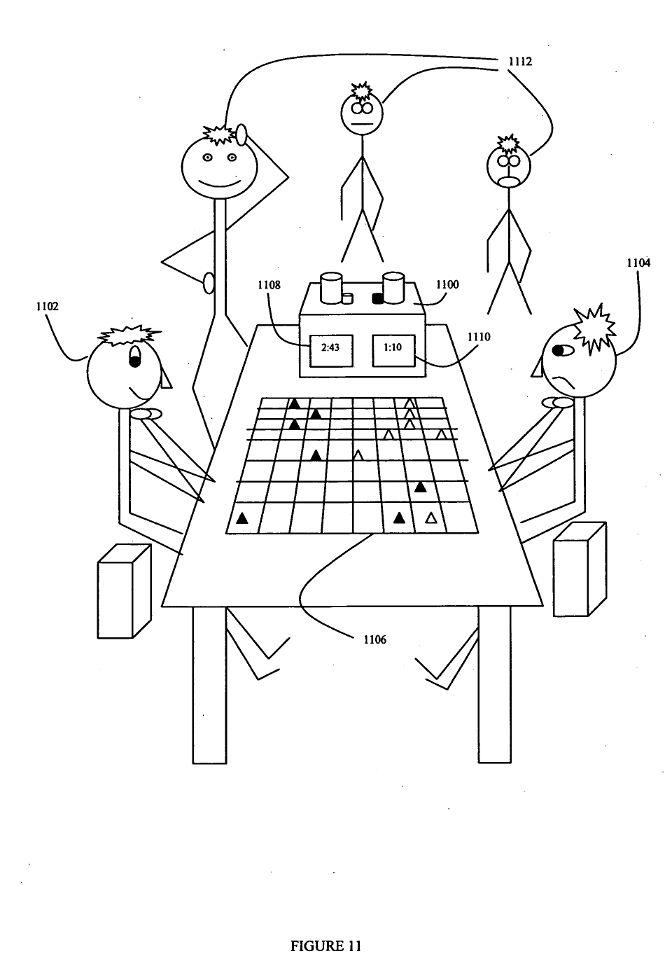

The chess clock is then placed to one side of the chessboard or the other. FIG. 11 illustrates an exemplary placement of a chess clock on the side of a chessboard. Note that the chess clock depicted in FIG. 11 is different from that depicted in FIG. 1. One difference is that the displays are digital rather than analog. Also note that the chess clock depicted in FIG. 11 is not a chess clock of the prior art. Generally, the player of the black pieces, who has the disadvantage of moving second, is allowed to choose the side of the chessboard on which the chess clock will be placed. Note that the chess clock in FIG. 11 is positioned approximately midway between the two players, so that each player can reach the clock button closest to him.

Now, continuing reference is made to FIG. 1. At the beginning of the game, the player of the black pieces will press the clock button nearest him (e.g., clock button 108), and will thereby activate his opponent's clock, “white's clock” (e.g., clock 106) and maintain his own clock, “black's clock” (e.g., clock 104) in its inactive state. White's clock 106 will advance until the player of the white pieces makes his move on the chessboard, e.g., by picking up a chess piece from one square and placing it on another. The player of the white pieces will then press the clock button 110 closest to him, thereby inactivating white's clock 106 and activating black's clock 104. It is now the turn of the player of the black pieces. Black's clock 104 will now advance until the player of the black pieces completes his move, and presses the clock button 108 nearest him. Once again, black's clock 104 is inactivated and white's clock 106 is activated. Throughout the course of the game, the procedure repeats itself, with each player's clock activated only when it is his turn, and with each player pressing the clock button nearest himself after completing a move. In this way, each player loses time on his clock only when it is his turn to move. Furthermore, each player may generally allocate his allotted time as he sees fit, spending relatively more time thinking about one move, and relatively less time thinking about another. Of course, the foregoing procedure is not always the way events unfold during a chess game. For example, a player may forget to press the clock button nearest himself after completing a move, and his opponent may therefore get some free thinking time at the player's expense.

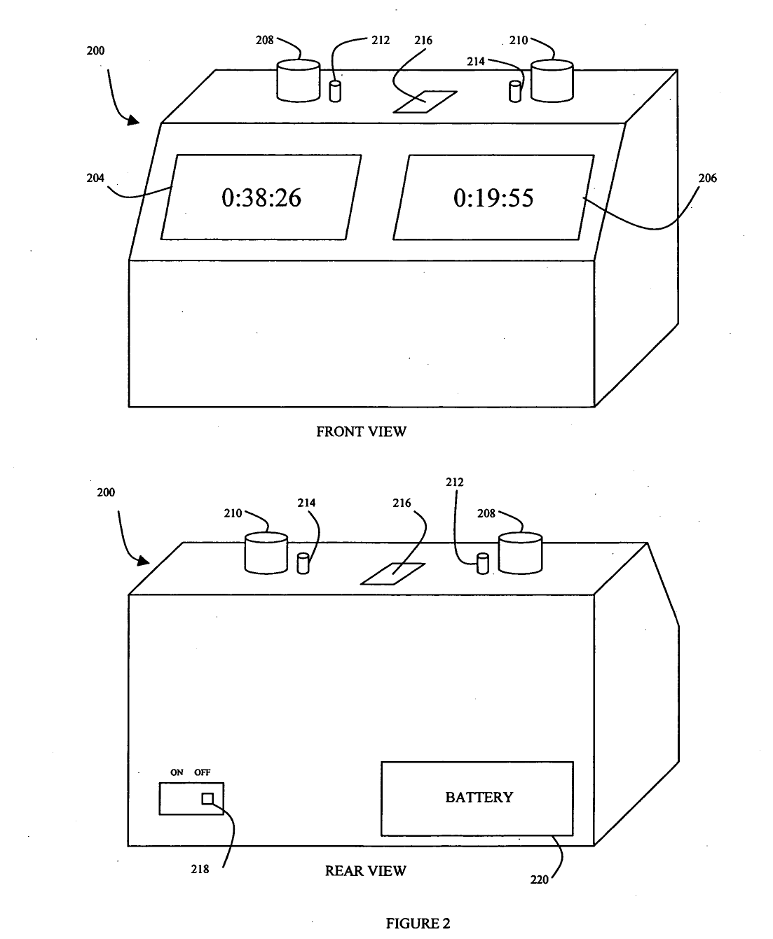

Reference is now made to FIG. 2, which depicts another exemplary chess clock 200 of the prior art. The chess clock 200 of FIG. 2 is powered electronically, e.g., using a battery. As such, the chess clock 200 of FIG. 2 is often termed a digital chess clock. Like the chess clock of FIG. 1, chess clock 200 contains two time displays 204 and 206. However, displays 204 and 206 are now electronic display screens (e.g., liquid crystal displays), rather than physical clock faces. Further, displays 204 and 206 display a time remaining as a sequence of numerals and colons, rather than as a position of two clock hands on a circular clock face. Displays 204 and 206 may, in addition, display other pieces of information, such as a move number, or an amount of time remaining in a grace period before a player will begin to lose time.

Clock buttons 208 and 210 are used, as described with reference to FIG. 1, to inactivate the clock of the player who has just moved, and to activate the clock of the player's opponent. However, unlike the clock buttons of FIG. 1, clock buttons 208 and 210 may not remain in a depressed state after a player has released them. Therefore, chess clock 200 contains two light indicators 212 and 214 to indicate whose turn it is. Thus, during a game, when it is white's turn to move, the light indicator corresponding to white's clock will be lit. When white later makes his move and presses his clock button, the light indicator corresponding to white's clock will go off, and the light indicator corresponding to black's clock will become lit.

Chess clock 200 lacks the knobs of FIG. 1, since there are no clock hands to set manually, and there is no spring to power manually. Instead, chess clock 200 contains an input button 216 which can be used to set the times on clocks 204 and 206, and to indicate any other features to be used during a chess game. For example, a player might press input button 216 three times in rapid succession in order to enter a “time set” mode. The player may then press the input button 216 once to give each player one hour, twice to give each player two hours, etc. Of course, a chess clock may contain multiple input buttons to make the selection among multiple times or among multiple functions easier.

The rear view of chess clock 200 shows two additional features. Power switch 218 is used to turn the chess clock on and off. Battery cover 220 covers the battery used to power the chess clock.

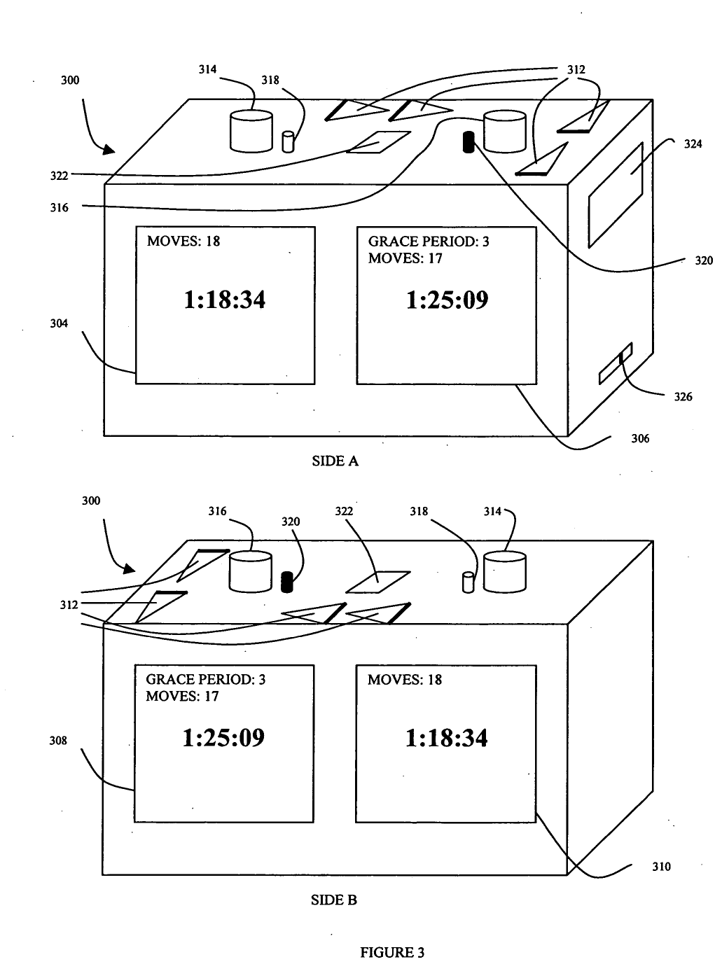

Reference is now made to FIG. 3, which depicts an exemplary embodiment of the present invention. FIG. 3 shows two views of a chess clock 300. The first view highlights a face of the chess clock labeled “side A”, and the second view highlights a face labeled “side B”. Side A shows two displays, 304 and 306. Side B also shows two displays, 308 and 310. The pattern of triangles 312 on the top of the chess clock 300 makes it clear that the two views illustrated in FIG. 3 correspond to the same chess clock 300 which has been rotated 180 degrees about a vertical axis going from one view to the other.

Displays 304, 306, 308, and 310 may be used to show various types of information. One type of information is an amount of time remaining. For example, display 304 (or any of the other displays) may read, “1:18:34”, which may indicate that a player has one hour, 18 minutes, and 34 seconds remaining to complete the first 40 moves of a chess game. Of course, a time remaining may be displayed in many different formats, which may or may not include hours, minutes, seconds, and fractions of a second. In addition, a time remaining may be displayed as a series of numerals (e.g., Arabic numerals) separated by colons, as representations of hands moving around a circular clock face, as an hour glass with sand falling out, or with any other representation. A second type of information is a number of moves made so far in a game. For example, as illustrated in FIG. 3, display 304 reads “Moves: 18” in order to indicate that one player has completed 18 moves. In one or more embodiments, the number of moves shown on a single display may indicate the number of moves completed by both players. For instance, a display might read “Moves: 33” to indicate that both players in a chess game have completed 33 moves. A third type of information is the amount of time remaining for a player in a grace period. A grace period may exist, for example, when a player has just pressed his own clock button. The player's opponent now has a five-second grace period in which to make a move and press his clock button, during which no time will be deducted from his clock. For each second beyond the five-second grace period that a player does not press his clock button, one second is deducted from his time remaining. As an example, display 306 reads “Grace Period: 3”, indicating that three seconds remain in a grace period. A fourth type of information is an amount of time that is being added to a player's time remaining. For example, after a player makes a move, five seconds may be added to his time remaining, and the clock may read “5”, or “5 seconds added”. The amount of time added may be termed the “time delay”. A fifth type of information may include instructional information. For example, when chess clock 300 is not currently in use for a chess game, but is being prepared for use, display 300 may display instructions indicating what sequence of input buttons to press in order to accomplish a given task. For instance, display 300 may read, “press input button 1 in order to set the hours.” A sixth type of information may include flashing or rotating indicia that may serve the function of a ticker. That is, such indicia may indicate that a clock is activated and may further mark units of time, such as seconds. Additional types of information may include, without limitation, information about players in a game (e.g., for the benefit of audience members), an amount of time used so far (as opposed to an amount of time remaining, discussed above), and a number of moves remaining.

Clock buttons 314 and 316 are used in a manner similar to the way in which clock buttons of the prior art are used. A player may press a clock button nearest him in order to inactivate his clock and activate his opponent's clock. When pressed, clock buttons 314 and 316 may remain in a depressed position and physically force the opposite button into a raised position. Alternatively, chess clock 300 may use light indicators in order to indicate whose turn it is. As depicted in FIG. 3, chess clock 300 contains two light indicators, 318 and 320. Light indicator 320 is currently lit, indicating that the corresponding clock, with 1:25:09 remaining, is active.

Input button 322 may serve a number of functions, and may generally allow a person to configure chess clock 300 to operate in a desired manner. Using input button 300, a person may set the amount of time to be given a player, the duration of grace periods, the amount of time to be added to a player's time remaining after the player makes a move (the time delay), the displays that are to be used during a game, and various other parameters. Although chess clock 300 is illustrated with only a single input button 322, chess clock 300 may contain multiple input buttons. Each of the input buttons may have specialized functions and may thereby allow a player to more easily configure chess clock 300 to operate in a desired manner. For instance, a first input button may be used to set the initial time remaining, a second input button may be used to set a grace period, and so on.

Battery case 324 covers a hollow area inside the chess clock where one or more batteries may be inserted. The batteries may be used to power the electrical components of chess clock 300. Power switch 326 may be used to turn chess clock 300 on and off. Turning the chess clock off when it is not in use may conserve battery power.

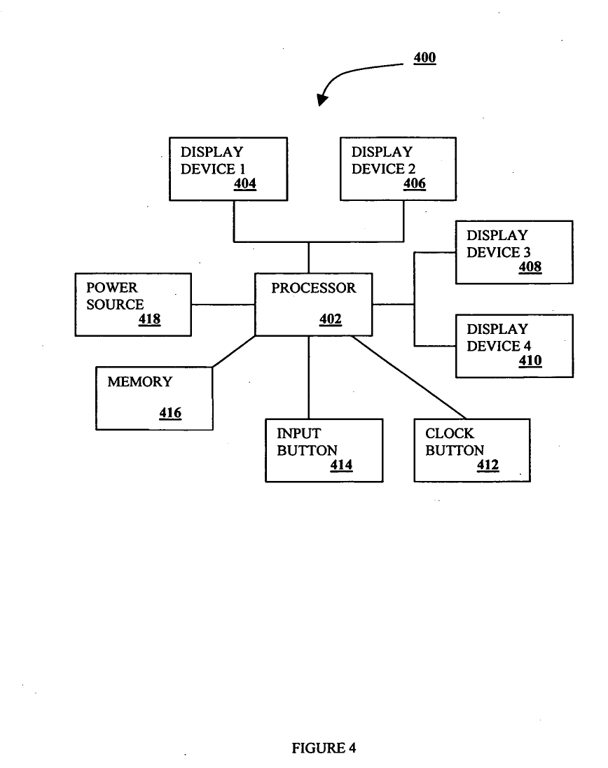

Reference is now made to FIG. 4, which depicts a schematic diagram of one or more embodiments of a chess clock 400 of the present invention. Processor 402 is in communication with displays 404, 406, 408, and 410; with clock buttons 412; with input buttons 414; with memory 416; and with power source 418. Processor 402 may be any integrated circuit or other device capable of executing logical functions. Exemplary processors include the Intel Pentium 44®, or the Advanced Micro Devices Athlon™ Processor. Although not shown, chess clock 400 may include an electronic oscillator that produces an alternating high and low voltage signal with a fixed period. As is well known in the art, the signal from the oscillator may serve as a reference signal for the processor, using which different logical components within the processor may operate in a coordinated manner. The oscillator may further operate at a known frequency, e.g., one gigahertz. Processor 402 may thereby use the signal from the oscillator to keep accurate time; e.g., measuring a second as one billion cycles of the reference signal from the oscillator. Memory 416 may be read only memory (ROM), electronically programmable read only memory (EPROM), random access memory (RAM), including dynamic random access memory (DRAM), or static random access memory (SRAM), or any other type of memory or combination of types of memory. In one embodiment, memory 416 stores program instructions that are executed by the processor in order to operate the chess clock in accordance with its function. Memory 416 may also store various data, including amounts of time remaining, numbers of moves completed in a chess game, and so on. Input buttons 414 may include buttons, switches, levers, dials, keypads, touch screens, computer mice, roller balls, or any other conceivable input devices. An input button may comprise, for example, a pressure sensor with a plastic cover. The pressure sensor may be part of an electric circuit. The pressing of the button by a person may change the resistance of the pressure sensor, thereby changing the amount of current to flow in the circuit. The change in current flow may be interpreted by the processor 402 as a signal. Input buttons 414 may therefore be used by a player to send signals to the processor 402, and to instruct the processor 402 to operate chess clock 400 in a desired manner. Clock buttons 412 may also include buttons, switches, levers, dials, keypads, touch screens, computer mice, roller balls, or any other conceivable input devices. Clock buttons 412 may be used by a player to signal to the processor that the player has made a move in a chess game. After receiving a signal from one of the clock buttons 412, the processor 402 may cease deducting time from a first clock and may begin deducting time from a second clock. That is, the processor 402 may inactivate the first clock and activate the second clock. Power source 418 may provide power for the processor 402 as well as any of the other components of chess clock 400. Power source 418 may be a battery, fuel cell, solar cell, combustion engine, or an attachment to a wall outlet.

Displays 404, 406, 408, and 410 may be liquid crystal display (LCD) screens, light emitting diode (LED) displays, organic light emitting diode (OLED) displays, cathode ray tube (CRT) displays, dot matrix displays, projection screens, neon displays, plasma screens, or any other type of displays. The displays may also be physical clock faces, with physical hands that move in circular patterns and point to stationary numbers. The displays are in communication with the processor 402, and may receive instructions from the processor as to what patterns or what information to display. For example, the processor may instruct display 404 to display the time “1:23”, representing an hour and 23 minutes remaining for a player. Each display may include one or more display controllers (not shown). Display controllers may, for example, store graphic information to be rendered on the corresponding displays. Display controllers may serve as intermediaries between the processor 402 and the displays. For example, the processor 402 may instruct the display controller to display the time “1:23”. The display controller may then interpret which pixels in the corresponding display(s) need to be darkened in order to display “1:23”. The display controller may then direct the corresponding display(s) to darken the necessary pixels. A display controller may also store the latest information provided by the processor, and provide such information to the corresponding display(s) as often as required. For example, the image shown on a display may be refreshed 30 times per second. Each time the display is refreshed, the display may require instructions from the display controller as to what pixels to darken. Rather than have the processor instruct the display 30 times per second to display the same time, “1:23”, the display controller may provide such instruction, thereby allowing the processor 406 to provide new instructions only when information to be displayed has changed.

FIG. 4 shows processor 402 with a single communication channel running to both displays 404 and 406. Similarly, processor 402 has a single communication channel running to both displays 408 and 410. An alternative configuration would have processor 402 in communication with a display controller (not shown), which in turn communicates with both displays 404 and 406. Similarly, processor 402 may be in communication with another display controller (not shown), which in turn communicates with displays 408 and 410. In these configurations, processor 402 may communicate the same information simultaneously to displays 404 and 406, and may thereby cause displays 404 and 406 to display the same information. Various embodiments of the present invention have displays 404 and 406 facing in different directions. Therefore, with displays 404 and 406 receiving the same information (e.g., information about an amount of time remaining for a player), the chess clock 400 of the present invention is able to show the same information to viewers who may not all be able to see a single display. Although FIG. 4 shows “groups” of displays consisting of two displays each (i.e. displays 404 and 406 in one group, and displays 408 and 410 in another), it is foreseen that groups may comprise any number of displays. In this way, for example, five different displays might all receive the same instructions from the processor, and may all display the same information. Also, although the chess clock 400 of FIG. 4 illustrates four displays, a chess clock according to the present invention may have as few as one display, and may also have any number of displays greater than one. The particular embodiment illustrated in FIG. 4 allows for two displays to correspond to each of two players. Each player may thereby have a first corresponding display on one side of a chess clock, and a second corresponding display on another side of the chess clock.

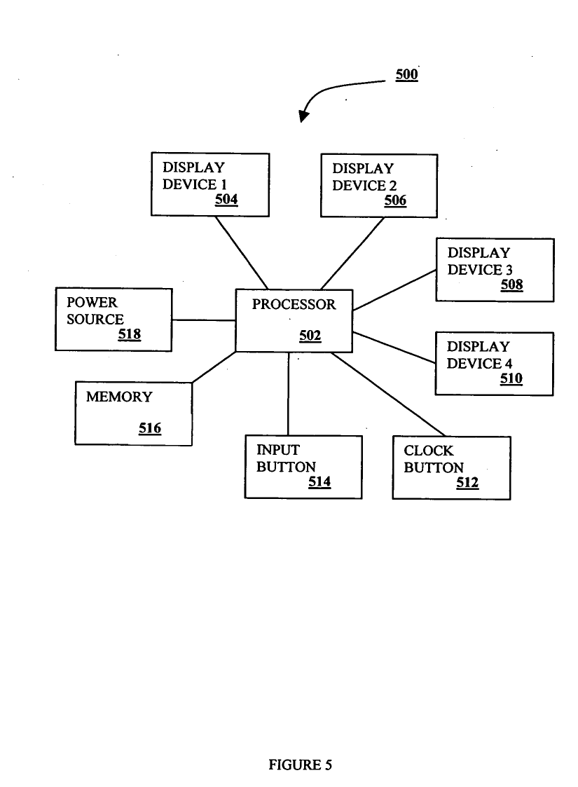

FIG. 5 shows a schematic diagram for one or more embodiments of a chess clock 500 of the present invention. The arrangement of FIG. 5 is similar to that of FIG. 4, except that in FIG. 5 the processor has separate connections to each display. Using the configuration of FIG. 5, processor may communicate different information to each of the displays. Thus, for example, even if displays 504 and 506 correspond to the same player, each may display information in a different way. For instance, display 504 may display a time remaining in hours and minutes only, whereas display 506 may display a time remaining using hours, minutes, and seconds. The time may be the same for both displays, only it may be shown differently.

FIGS. 4 and 5 depict two exemplary configurations for components of a chess clock of the present invention. However, it should be understood that many other configurations are possible and contemplated by the present invention. For example, a chess clock may include a memory in direct communication with one or more display devices (e.g., there may be a signal bus linking the memory to the one or more devices). As the memory updates various information about a player, such as a time remaining, the information may be transmitted directly to the one or more display devices for display. However, whether or not two components of a clock are directly linked (e.g., by a signal bus), or indirectly linked (e.g., component A and component B are both linked to component C, which relays signals from component A to component B, or vice versa), the two components of the clock may be said to be “linked,” “connected,” “coupled,” or “in communication” with one another. Further, where the connection between two components is mechanical in nature (e.g., two components are connected with screws, adhesives, hinges, bolts, are both connected to the same physical structure, or are both connected to physical structures which are themselves connected), the two components may be said to be “mechanically connected” or “attached.” However, it should be noted that two components that are mechanically connected or attached may still have some play relative to one another. For example, a clock button, though it may be mechanically connected to the body of a chess clock, may still move up and down relative to the body. Additionally, where the connection between two components is electrical in nature (e.g., the two components are connected via signal bus), the two components may be said to be “electrically connected.”

In various embodiments of the present invention, a chess clock may comprise a plurality of memories or memory locations. Each of the plurality of memories or memory locations may store the same or similar information. For example, memory A may store the amount of time remaining for a player in a game, and memory B may store the amount of time remaining for the same player in the game. In addition, a first of the plurality of memories or memory locations may be in communication with a first display device, and a second of the plurality of memories or memory locations may be in communication with a second display device. Thus, the first display device may receive player information from the first of the plurality of memories or memory locations, and the second display device may receive player information from the second of the plurality of memories or memory locations. One advantage of having a plurality of memories or memory locations each storing the same information is that display devices situated far apart need not necessarily communicate with the same memory or memory location in order to receive updated information about a player. Rather, each display device may communicate with a respective memory or that is proximate to the display device. Where the same or similar information is stored in a plurality of memories or memory locations, the memories or memory locations may be synchronized on one or more occasions. For example, at the start of a chess game, each of two memories may be initialized with a time remaining for a player of a game. The two memories may thereupon be updated separately, each separately tracking the time remaining for the player of the game. After a predetermined time interval, such as an hour, the processor of the chess clock may poll the first of the two memories for an indication of the time remaining. The processor may then send an indication of such time to the second of the two memories. The second of the two memories may then update its own locally stored time remaining to reflect the time remaining as stored in the first of the two memories.

In embodiments where a time remaining for a player is stored in two separate memories or memory locations, a first of the two memories or memory locations may be considered as the primary or standard memory or memory location. Thus, a player may be considered to run out of time only if his time remaining as stored in the primary memory has reached zero, regardless of whether or not it has reached zero in another memory.

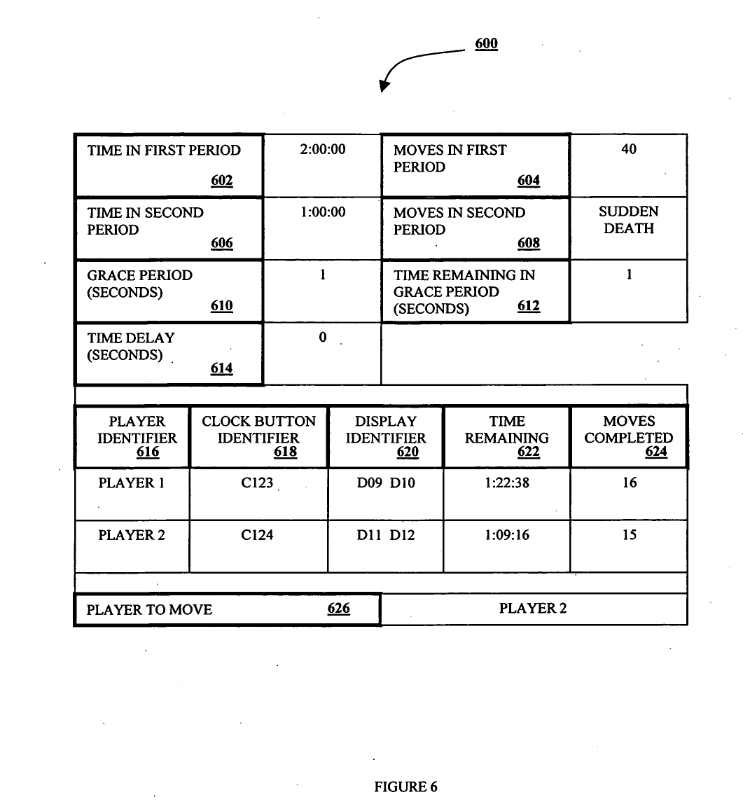

Reference is now made to FIG. 6, which depicts an exemplary game database 600. Game database 600 may be stored in memory 416 and may allow processor 402 to operate chess clock 400 according to game conventions stored within. Field 602 stores the time allowed for each player in the first period of a game. Field 604 stores the number of moves that make up the first period of the game. In this example, each player has two hours (the time in the first period) to complete forty moves (the number of moves in the first period). Field 606 stores the time in the second period and field 608 stores the number of moves in the second period. In this case, field 608 is populated with “sudden death”, which means that each player must complete all remaining moves by the end of three hours (the time in the first period plus the time in the second period). It should be understood that there may be fields for a third period, fourth period, etc., or there may be fields for only a first period. Field 610 stores the time allowed for any grace period. In this case, there is a one-second grace period, which means that a player may make a move within one second of it becoming his turn, without losing any time. Field 612 stores the amount of time remaining in a grace period. As time elapses during a grace period, the contents of field 612 may be decremented. When the contents of field 612 reach zero, processor 402 may begin deducting time from the clock of the player whose turn it is to move. When a player completes his move, the contents of field 612 may be reset to match the contents of field 610. Field 614 stores the duration of any time delay. In this case, there is no time delay. In other words, no time is added to a player's clock after he completes his move. Field 626 stores the identifier of the player whose move it is. Field 626 may allow the processor 402 to track which player is to move, and therefore from which player's clock time should be deducted. In this example it is Player 2's turn to move. Therefore, as time elapses and player 2 does not move, player 2's clock will go from 1:09:16, to 1:09:15, and so on.

Game database 600 also contains two records. The first field in each record is the player identifier field 616. The player identifier identifies the player to which the rest of the information in each record corresponds. Exemplary player identifiers are listed as “player 1” and “player 2”. Player identifiers may consist of any sequence of characters, and need not spell out actual player names, although they might. For games involving three or more players, there may be more than two records. Field 618 of each record stores a clock button identifier. When a clock button sends a signal to the processor 402, the signal may include the identifier of the originating clock button, so that the processor can tell which clock button the signal came from. The processor 402 may then cease deducting time from the corresponding player, and begin deducting time from the player's opponent. For example, if processor 402 receives a signal from clock button C123, then processor 402 can determine from the database 600 that player 1 has just pressed his clock button (thus causing the signal). Processor 402 may then stop deducting time from player 1, and begin deducting time from player 2. Of course, there are many other ways by which the processor 402 might identify the clock button from which a signal has been received. For example, the processor 402 might have separate wire connections to each clock button, and may determine the originator of a signal by the wire connection via which the signal has been received.

Field 620 of each record contains zero or more display identifiers. In the game database 600 of FIG. 6, each record contains two display identifiers, indicating that there are two displays corresponding to each player. The two displays corresponding to each player may be, for example, on opposite side of a chess clock and facing in opposite directions. The processor 402 may communicate information to a display by, for example, appending the corresponding display identifier 620 to any signal meant for the display. Alternatively, the processor 402 may have a separate wire connection to each display and may communicate with an intended display by using the appropriate wire connection in order to transmit and receive information. Field 622 of each record stores a time remaining for the corresponding player. For the player whose turn it is to move, the processor 402 may continually update field 622, e.g., by deducting a second from the time remaining as each second elapses. It should be noted that, as used herein, a player's “clock” may refer to the player's time remaining as stored in field 622 of the player's corresponding record. Field 624 of each record stores the number of moves completed during the current game for the corresponding player. Each time the processor 402 receives a signal from the clock button of a player, the processor may update field 624 of the corresponding record by incrementing the moves completed by one. Of course, if it is not the player's turn when he presses the clock button, processor 402 may simply ignore the signal from the clock button. As will be understood by those skilled in the art, database 600 may contain numerous other fields, and may contain variants of the fields shown. For example, database 600 may contain a “time elapsed” field rather than a “time remaining” field. Additionally, it should be understood that all data illustrated in the database is exemplary, and that many other data values are possible.

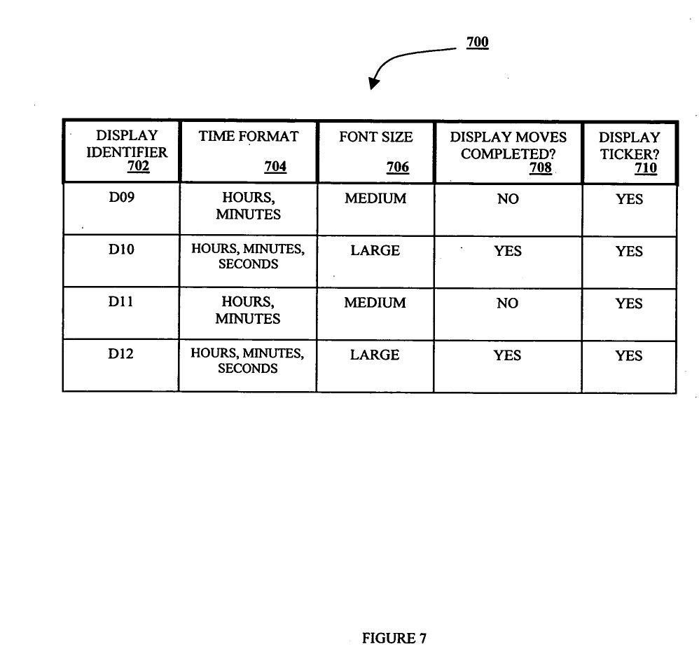

Reference is now made to FIG. 7, which contains an exemplary display database 700. In one or more embodiments, the display database may be used by the processor 402 or by a display controller in order to determine what information is to be shown on a display, and how the information is to be presented. Each record in display database 700 corresponds to a display on a chess clock of the present invention. Field 702 stores a display identifier that may be used by the processor 402 to identify the corresponding display. Field 704 stores a time format. The time format may indicate the manner in which a time remaining, or any other time is to be displayed on the corresponding display. Exemplary time formats are “hours, minutes” and “hours, minutes, seconds”. A time displayed in “hours, minutes” format may show the hours and the minutes, but not seconds. For example, “0:58” indicates that there are zero hours and 58 minutes remaining. A time displayed in “hours, minutes, seconds” format may show the hours, minutes, and seconds. For example, “0:58:23” indicates that there are zero hours, 58 minutes, and 23 seconds remaining. Many other time formats are possible. For example, a “clock face, hours, minutes” format may indicate that a time is to be displayed as a round clock face with an hour and minute hand. Note also that a display might show a time in different formats depending on one or more variables. For example, if a time remaining is less than 10 minutes, then a display may switch from displaying a time in “hours, minutes” format to “hours, minutes, seconds” format.

Field 706 stores a font size to be used by a display. Exemplary font sizes are “large”, “medium”, and “small”. Font sizes may also be listed in terms of inches, points, or any other unit. The font size field 706 may indicate the size with which a display is to show any numerals or characters, such as a time remaining. A font size may even apply to non-characters, such as pictures, symbols, or a ticker. Alternatively, another field may be used to indicate a picture, symbol, or ticker size. It may be desirable to display characters in a relatively smaller font size if a display is facing a player, since the player will generally be close to a display during the course of a chess game. However, for a display that faces away from a player and towards an audience that is further away, it may be desirable to display characters in a relatively larger font size. In the display database 700 of FIG. 7, displays D09 and D10 may correspond to the same player and may therefore display the same amount of time remaining. However, display D09 may face towards the player, and D10 may face away. Therefore, display D09 displays characters in “medium” font size, and display D10 displays characters in a “large” font size.

Field 708 stores an indication for each display as to whether or not to show a number of moves completed. Exemplary entries are “no” and “yes”. If an entry is yes, then the corresponding display may indicate a number of moves completed. The display may indicate the number of moves completed by the corresponding player, by the player's opponent, or by both. For example, if a player has just completed 15 moves, then his corresponding display(s) may show “15”. Of course, the display(s) may simultaneously show the time remaining for the player.

Field 710 stores an indication for each display as to whether or not to show a ticker. Exemplary entries are “yes” and “no”. An entry of “yes” may indicate that the corresponding display is to show a rendition of a ticker. A rendition of a ticker may aid players in determining whose turn it is, and in tracking the passage of time.

As can be seen, the display database 700 of FIG. 7 allows for different displays on a chess clock to display different information, and to display information in different formats. Users of the chess clock may customize the display settings to suit the circumstances of the game. It should be understood that many other fields are possible in the display database. In one embodiment, a field would indicate whether a particular display would display any information at all. A “no” entry in such a field might render the display inoperative for the duration of a game. It might be desirable for a display to be rendered inoperative if, for example, players at a nearby game would be confused by the display. For example, the display might be facing in the direction of the nearby game, and might make the players of that game think that the display was indicating their own time remaining.

It should also be understood that the data stored in databases 600 and 700 may be stored in any number of configurations, and need not appear as shown in the figures. For example, the data stored in database 600 may be spread over multiple databases, or may stored in a larger database with other information.

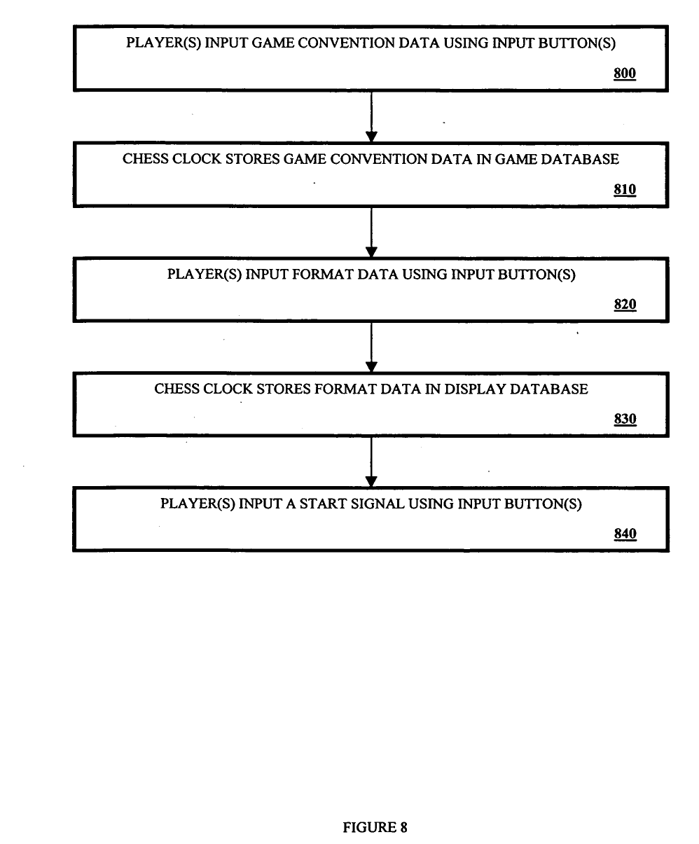

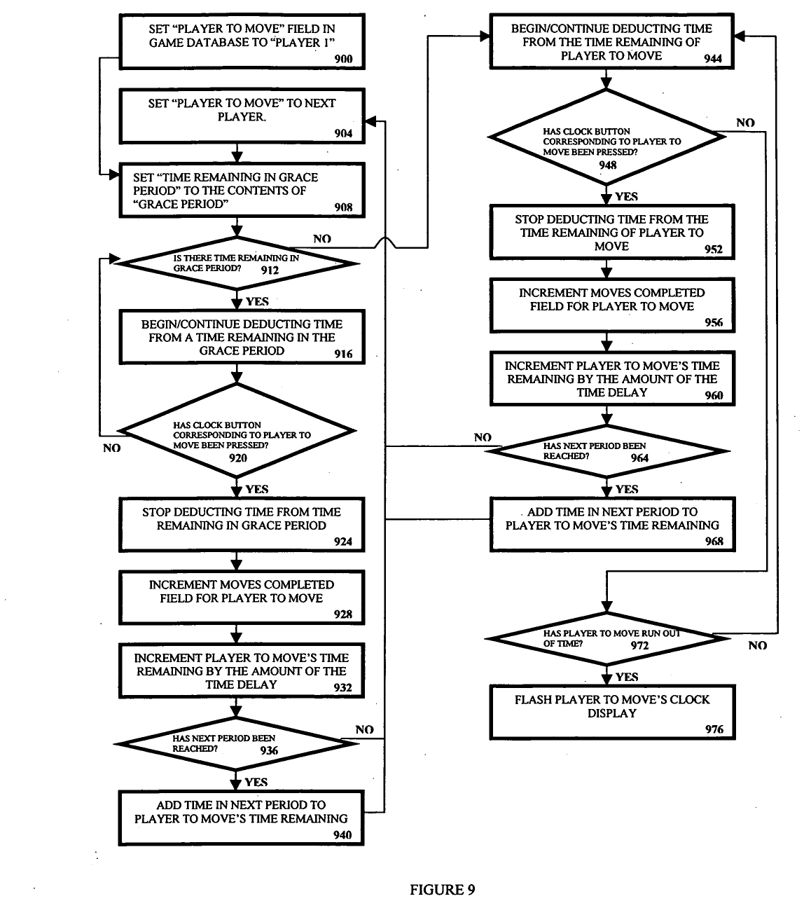

An exemplary process carried out by the chess clock of the present invention will now be described with reference to FIGS. 8 and 9.

FIG. 8 is a flowchart illustrating an initialization process for a chess clock of the present invention. At step 800, one or more players or other parties inputs game convention data using the input buttons 414 of the chess clock. Game convention data may convey to the chess clock information such as the number of periods during a game, the number of moves contained within each period, the time allotted to each player for each period, the amount of the time delay, the amount of the grace period, and any other pertinent information. A person may input game convention data in many ways. In one or more embodiments, the chess clock may contain a numeric keypad by which the person can enter amounts of time, numbers of moves, numbers of periods, and any other numeric information. For example, the person may key in 1:00 when entering the amount of time in the first period. In another embodiment, the person may repeatedly press a single button in order to increment a given number. For example, each press of a button adds five minutes to the amount of time each player is to have in the first period. In yet another embodiment, the person may press a button to select from a default set of game convention data. For example, by pressing a button labeled “default”, the person may select game convention data that specifies a single period of sudden death, with no time delay and no grace period. Alternatively, the default game convention data may be the game convention data that was in place during the prior use of the chess clock. As will be appreciated, there are numerous other ways by which a player might enter game convention data. It should be noted that even prior to entering game convention data, a player may turn the chess clock on by, for example, switching on/off switch 326.

After one or more parties have entered the game convention data, the processor may at step 810 direct the memory to store game convention data in a database such as that of FIG. 6. Then, at step 820, one or more parties may enter format data using the input buttons 414. Format data may convey to the chess clock indications of how information will be displayed on one or more displays of the chess clock. Format data may indicate how a time is to be displayed, e.g.: in terms of hours and minutes; hours, minutes and seconds; minutes and seconds; minutes, seconds, and hundredths of a second; and so on. A time may also be displayed as an hourglass with sand falling out, or as a circular clock face with moving hands. Format data may also convey to the chess clock the font, font size, font style, font color, or any other customization of text that may be desired by the player. For example, a player may input format data that directs the chess clock to display text in medium size, Times New Roman font, italicized, and with underlining. The player might even provide format data indicating that a displayed time should flash, but only when the displayed time is under five minutes.

Format data may also indicate what information is to be displayed on a display. Format data may indicate, for example, whether a display is to show the number of moves completed by a player thus far in a game, whether a display is to show a player name or rating, whether a display is to show a time elapsed since the last move was completed, whether a display is to show a ticker, and so on.

One feature of the present invention is that, in one or more embodiments, a person may provide separate format data for separate displays on a single chess clock. Thus, for example, a person might indicate using format data that a first display is to show a time remaining in large font, while a second display on the chess clock is to show a time remaining in smaller font. In another example, a first display might show a player's name, while a second display does not. One advantage of providing different format data to different displays is that the each of the displays may then present information in a way that is tailored to a likely viewer. For example, one display on a chess clock might be facing away from the players and towards an audience. Since the audience may be relatively far away, the display may present information in large font. Furthermore, the display may show the name of a player (e.g., of the player whose time remaining the display shows). Another display that faces the player may display the same information, but in smaller font, since the player is the likely viewer and does not need large font to see. In fact, the display may not even present the player's name, since the player presumably knows it already. If a display faces the players of a nearby chess game, then the display may show a time remaining in an a typical color, such as red. In this way the nearby players will not mistake the chess clock for that belonging to them, and will therefore not hit the buttons of the chess clock. In some cases, format data may indicate that a display should not show any information, but should remain blank.

Format data may also indicate which displays are to correspond to which players. For example, input information may indicate that a first and second display will correspond to a first player, and a second and third display will correspond to a second player. A display is said to correspond to a player when, for example, the display shows information about the player, such as the time remaining for the player, the player's name, the number of moves completed by a player, and so on. It should be noted, however, that some displays may correspond to neither player. For instance, some displays may show general information, such as the time of day, the position on the chessboard, or the number of moves completed in the game so far. Also, some displays may correspond to both players. For instance, some displays may show the names of both players, and the time remaining for both players. However, even if a display corresponds to both players, one or more embodiments may allow that different areas on the display be treated as separate displays. For example, the right side of a display (e.g., the side nearest player 1), may correspond to player 1 and show information about player 1, whereas the left side of a display (e.g., the side nearest player 2), may correspond to player 2. One convenient way to assign displays to correspond to players is not to name players, but to assign displays instead to clock buttons. Thus, for example, if a display is assigned to correspond to clock button 1, then the display automatically corresponds to the player who uses clock button 1 during the game. In this way, the processor need not be provided with a player name, and the processor need not guess, for example, that player 1 just pressed a clock button, so player 2's clock should now be activated. Assignment of displays to players may be recorded in the game convention database of FIG. 6. In the first exemplary record of FIG. 6, player 1 corresponds to clock button C123, and displays D09 and D10. Thus, when the opposite clock button (C124) is pressed, player 1's clock will be activated and displays D09 and D10 may show player 1's time remaining decrementing. When player 1 later makes a move and presses his own clock button C123, then player 1's clock may be inactivated, and displays D09 and D10 may statically display player 1's time remaining. To allow for the easy assignment of displays to clock buttons, displays and clock buttons may be physically labeled on the exterior of the chess clock. In this way, a person might use input buttons to enter a clock button identifier (e.g., “C123”) and then identifiers for one or more displays to correspond to the clock button (e.g., “D09” and “D10”). For the rest of the game, the processor may then associate clock button C123 with displays D09 and D100. Note also that there may be a default correspondence of displays to clock buttons, so that a player need only select “default” or even do nothing, in order to attain the default correspondence. As an example of default assignments, suppose two clock buttons are on opposite sides of a chess clock that has the overall shape of a rectangular prism (e.g., the chess clock 300 of FIG. 3). The clock buttons may thereby define a right side (clock button 314) and a left side (clock button 316) of the chess clock. Displays falling on the right side (e.g., displays 304 and 310) may correspond, by default, to the clock button 314 on the right side, and displays falling on the left side (e.g., displays 306 and 308) may correspond to the clock button 316 on the left side.

In one or more embodiments of the present invention, it is envisioned that a large number of displays may limit the amount of room on the outer surface of a chess clock in which to place input buttons. Thus, a person might have trouble entering a diverse set of game convention and format data using the limited number of input buttons that may be present. Therefore, in one or more embodiments, the chess clock of the present invention may receive voice inputs from a person. For this purpose, the chess clock may possess one or more microphones for detecting sounds. The chess clock may also contain a voice recognition program. A player might use his voice to issue such commands as, “set time remaining in first period,” “set grace period,” or “set font size.” The player might then speak numeric digits such as “1,” “0,” “0,” to indicate one hour. Alternatively, the player may just speak the words “one hour.” As will be appreciated by those skilled in the art, there are many other ways in which voice can be used to control an electromechanical device, such as a chess clock. The chess clock may also possess voice-synthesizing capabilities, and may respond to player inputs using synthesized voice, or using pre-recorded voice. For example, the chess clock may say, “could you repeat that last command” or, “is the time now displayed what you asked for?”

After one or more parties have entered the format data, the processor may at step 830 direct the memory to store format data in a database such as database 700 of FIG. 7. Note that the database 700, although it need not do so, stores separate records for each display of the chess clock. Therefore, each display may present different information, and may present even similar information in different ways. At step 840, a player may enter a start signal using input buttons 414. The start signal may alert the processor to begin deducting time from a player's clock once the next signal is received from a clock button. When a player does press a clock button, then the chess game has begun, and processor 402 may now operate according to the flow chart depicted in FIG. 9.

Although the flow chart of FIG. 8 presents steps in a particular order, it should be understood that the steps of FIG. 8 may be performed in any practicable order. For example, format data may be input prior to game convention data, or both types of data may be input in alternating fashion. Also, format or game convention data may be input even after a person has input a start signal, and the game is under way.

Reference is now made to FIG. 9, which illustrates exemplary steps performed by chess clock 402 during the course of a chess game. After one of clock buttons 412 has been pressed, the processor 402 designates the opposite player (the player whose clock has now been activated), as player 1. At step 900, the processor sets the “player to move” field 626 in game database 600 to “player 1”, indicating that it is now player 1's turn to move. Incidentally, “player 1” is an arbitrary designation which could just as well be “first player”, “white”, or “Sam Jones” e.g., if the player's name is known. Flow now skips to step 908, where the “time remaining in grace period” field 612 of database 600 is initialized to the contents of “grace period” field 610. Thus, for example, if the current game is being played with a grace period of 5 seconds, as would be indicated in field 610, then player 1 initially receives 5 seconds in which to move without having any time deducted from his time remaining. Flow now proceeds to step 912, where the processor 402 checks time remaining in grace period field 612 to determine whether player to move has any time remaining in the grace period. If player to move does have time remaining in his grace period, then flow proceeds to step 916, where the processor 402 begins or continues deducting time from player to move's grace period. As time is deducted from the grace period, time remaining in grace period field 612 may be continually updated to reflect the new amount of time remaining. As time is deducted from the time remaining in grace period, all displays showing the time remaining in the grace period may be continually updated to reflect the new time remaining. From step 916, flow proceeds to step 920, where processor 402 determines whether the clock button corresponding to player to move has been pressed. If the clock button has not been pressed, then it is still player to move's turn, and flow may loop back to step 912, where once again the processor 402 determines whether there is any time remaining in the grace period for the player to move. If, however, at step 920, the clock button corresponding to player to move has been pressed, then flow proceeds to step 924. At step 924, the processor stops deducting time from the time remaining in grace period. Flow then proceeds to step 928, where the moves completed field for player to move is incremented. Thus, for example, if player to move had completed 0 moves, then the moves completed field of the record in game database 600 corresponding to player to move would be incremented to 1 move. Thus, chess clock 400 interprets the pressing of a clock button as a completion of a move by a player. From step 928, flow proceeds to step 932, where player to move's time remaining is incremented by the amount of the time delay. The amount of the time delay may be obtained from field 614 in game database 600. For example, player to move's clock reads 0:59:48, and the time delay is 5 seconds, then player to move's clock is incremented to read 0:59:53. From step 932, flow proceeds to step 936, where the processor determines whether the next period has been reached. For example, the first period of a game may last 30 moves, as may be indicated by field 604 of game database 600. In this example, at step 936; processor 402 would determine whether moves completed by player to move have reached 30 moves (assuming it is currently the first period of the game). If processor 402 determines that the next period has been reached, then the processor 402 may increment player to move's time remaining by the time in the next period. For example, if the second period of a game provides a player with an additional hour (e.g., as indicated by time in 2^{nd} period field 606 of game database 600), then player to move's time remaining may be incremented by an hour. If it is currently the last period of a game (e.g., it is a period of sudden death, where all moves must be completed within a fixed time period), then of course processor 402 need not determine whether or not the next period has been reached. If the next period has not been reached, then flow goes back from step 936 to stop 904. If the next period has been reached, then after the time in the next period is added to player to move's clock at step 940, flow also proceeds to step 904. At step 904, processor 402 sets player to move 626 to the next player. For example, if player to move 626 had been player 1, then player to move 626 may now be set to player 2. Alternatively, if player to move 626 had been player 2, then player to move 626 may now be set to player 1. If the game involves more than 2 players, then player 2 may succeed player, 1, player 3 may succeed player 2, and so on, with player 1 succeeding the last player. From step 904, flow proceeds to step 908, and the process described above may be repeated, but now with a new player.

Another branch of the flow chart of FIG. 9 will now be considered. If at step 912, the processor 402 determines that there is no time remaining in the grace period, then flow proceeds to step 944. At step 944, processor 402 may begin or continue deducting time from the clock of the player to move. As time is deducted, all displays showing the time remaining for player to move may be continually updated to reflect the new time remaining. Flow now proceeds somewhat analogously to that of steps 916 to 940. At step 948, the processor 402 determines whether the clock button corresponding to player to move has been pressed. If it has, then flow proceeds to step 952. At step 952, the processor stops deducting time from player to move's clock. Then, at step 956, the processor increments the moves completed field 624 for player to move by 1. Then, at step 960, the processor increments player to move's time remaining by the amount of the time delay. At step 964, processor 402 determines whether the next period has been reached. If the next period has been reached then, at step 968, the amount of time in the next period is added to player to move's time remaining. Flow then loops back to step 904. Even if the next period has not been reached, flow proceeds back to step 904.

Referring back to step 948, if the clock button corresponding to player to move 626 has not been pressed, then flow proceeds to step 972. At step 972, processor 402 determines whether player to move 626 has run out of time. For example, has the time remaining for player to move 626 reached zero? If player to move 626 has run out of time, then flow proceeds to step 976. At step 976, processor 402 may direct one or more displays corresponding to player to move 626 to flash, so as to indicate that player to move 626 has no more time. In one or more embodiments, only displays that are facing away from the players may be directed to flash or to otherwise draw attention. For example, only displays facing an audience may flash. In this way, as is typical in many tournaments, it is still incumbent upon the opponent of player to move 626 to notice that player to move has run out of time. The chess clock does not necessarily call this circumstance to the attention of the player to move's opponent. If however, at step 972, player to move 626 has not run out of time, then flow may loop back to step 944, where the processor may continue deducting time from player to move 626.

It should be understood that the steps illustrated in the flow chart of FIG. 9 are exemplary of one or more embodiments, and that many other possible situations have not been described. For example, in the middle of a chess game, a player may employ input buttons 414 to inactivate the clocks of both players simultaneously. In other words, neither player will have time being deducted. Such a situation is common when, for example, one player wishes to involve the tournament director in a claim or a dispute. The player may inactivate both clocks in order to give himself time to find the tournament director. In another common situation, one player may make an illegal chess move. The consequence is that the player's opponent may receive additional time for his time remaining. Therefore, a player, tournament director, or other party may employ input buttons 414 to add time to a player's time remaining.

It should also be understood that the steps illustrated in FIG. 9 need not necessarily be practiced in the order in which they are shown. Some steps may be reversed, combined, or performed simultaneously. Additional steps may be inserted, or steps may be eliminated.

Exemplary Dimensions

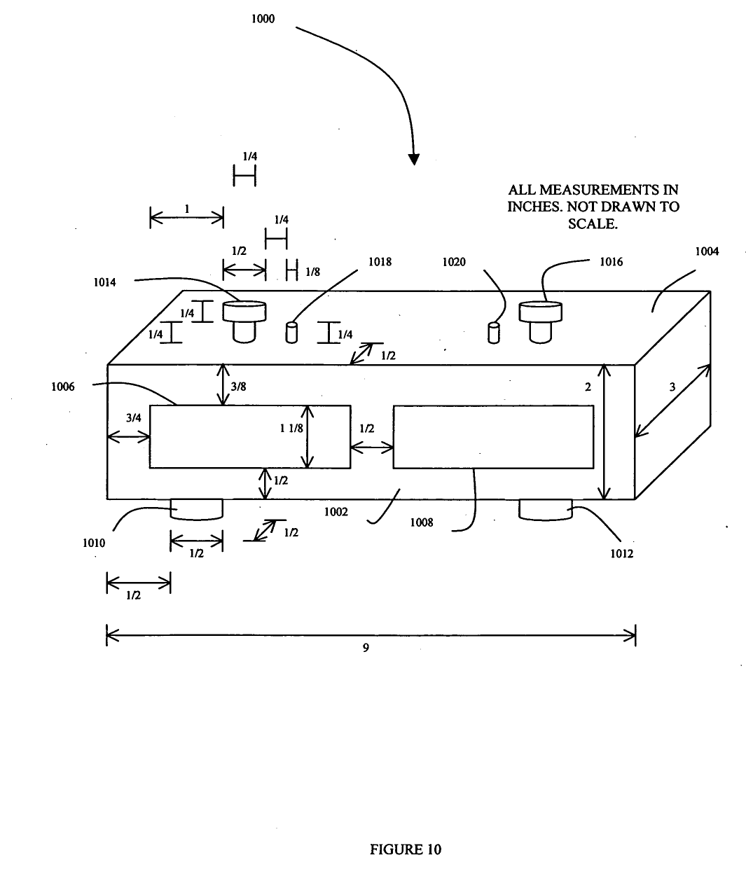

Exemplary dimensions of a chess clock of the present invention will now be described. FIG. 10 illustrates an exemplary chess clock 1000. The exemplary chess clock 1000 has the general shape of a rectangular prism. Its dimensions are 9 inches long, by 2 inches high, by 3 inches deep. The two faces measuring 9 inches by 2 inches will be designated “front” 1002 and “back” (not shown). The two dimensions measuring 3 inches by 9 inches will be designated “top” 1004 and “bottom” (not shown). The front 1002 of the chess clock 1000 contains two rectangular displays 1006 and 1008, each measuring ½ inches long by 1 and 1/8 inches high. Each display is oriented with edges parallel to those of the front face 1002 of the chess clock. Each display has its outermost side edge 3/4 inch from one side of the front face 1002 of the chess clock 1000, and its uppermost edge ⅜ of an inch from the top of the front face 1002 of the chess clock 1000. The two displays are thus 1/2 inch apart at their innermost side edges, and are each ½ inch from the bottom edge of the front face 1002 of the chess clock at their lowermost edges. The back face of the chess clock 1000, although not shown, appears identical to the front face 1002, at least when no information is shown on any display. The back face also contains two displays. The chess clock 1000 therefore has a total of four displays. On its bottom face, the chess clock 1000 has four “feet”. Two of them, 1010, and 1012, are visible in the figure. The feet come in contact with the surface on which the chess clock 1000 rests (e.g., a table), and support the body of the chess clock 1000 above the surface. The feet have the approximate shape of circular cylinders, ½ inch in diameter, and 1/4 inch high. The feet are located ½ each from each of the two nearest edges of the of the bottom face of the chess clock 1000.

On its top face, the chess clock 1000 has two clock buttons 1014 and 1016. The exposed portion of each button consists of a wide upper portion and a narrow lower portion. The upper portion has the shape of a circular cylinder ½ inch in diameter and 1/4 inch tall. The lower portion has the shape of a circular cylinder 1/4 inch in diameter and 1/4 inch tall. The circular cylinders composing each portion of each button are oriented with axes parallel to the vertical. Each clock button is situated 1 inch from the 3-inch edge of the top face 1004 of the chess clock 1000, and ½ inch from the 9-inch edge shared by the top face 1004 and the front face 1002 of the chess clock 1000. The two clock buttons 1014 and 1016 are on opposite sides of the top face 1004 of the chess clock 1000, but both are located nearer the front face 1002 of the chess clock 1000 than the back face. Next to each clock button on the top face 1004 of the chess clock 1000 is a light indicator. The two light indicators are shown with reference numerals 1018 and 1020. The light indicators are approximate circular cylinders with 1/8 inch diameters and standing 1/4 inch tall. The light indicators are located ½ inch back from the 9 inch edge of the chess clock 1000 shared by the top 1004 and front 1002 faces. The light indicators are also located 1/4 inch from their respective clock buttons, and are closer to the center of the top face 1004 than are the clock buttons.

Exemplary Uses

Reference is now made to FIG. 11, where a chess clock 1100 is shown as it might be used in a tournament setting. In the foreground, two players 1102 and 1104 sit across from one another at a chessboard 1106. The displays, 1108 and 1110, that are visible in the figure would therefore also be visible to the players 1102 and 1104. In the background stand several spectators 1112 to the chess game. The spectators 1112 are situated such that the chess clock is between the players, 1102 and 1104, and the spectators 1112. Thus, with displays 1108 and 1110 facing towards the players, the same displays cannot be seen by the spectators 1112. Were chess clock 1100 a chess clock of the prior art, spectators 1112 would not be able to view the time remaining for either player. To do so, spectators 1112 would have to walk around to the other side of the chess clock, where they might distract the players, or where they might be bumped by other spectators. However, as chess clock 1100 is a chess clock according to one or more embodiments of the present invention, chess clock 1100 has two additional displays on the opposite face to the face containing displays 1108 and 1110. Though these displays cannot be seen in the figure, they would be visible to the spectators.

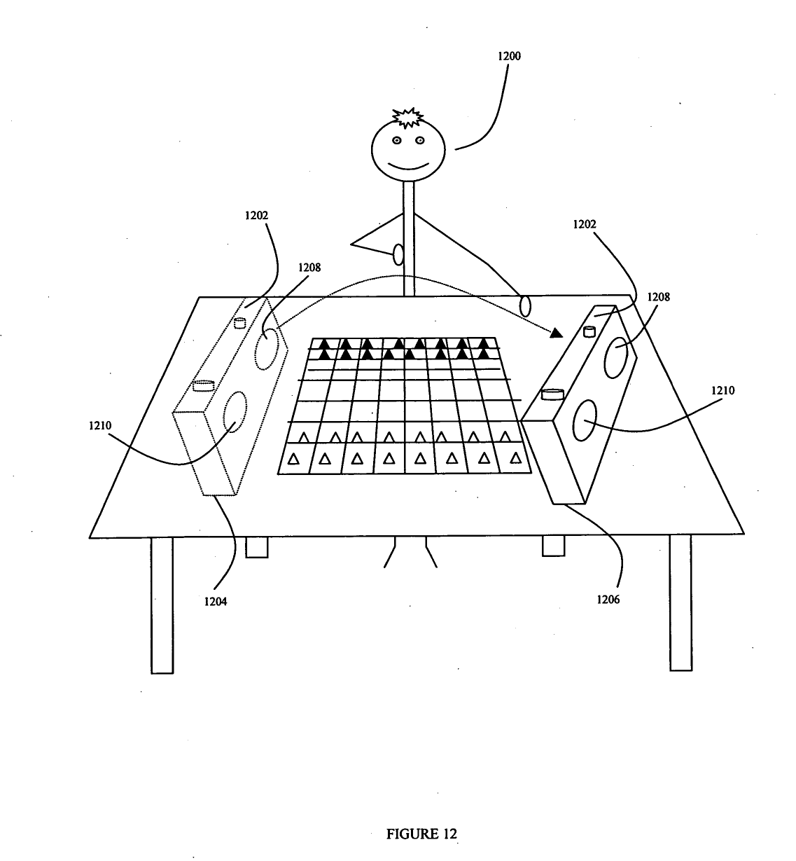

Reference is now made to FIG. 12. In the figure, the player of the black pieces 1200 has just arrived late to a chess game. The chess clock 1202 is initially located to his right, and his clock has already been activated by his opponent. Display 1208 displays player 1200's time remaining. Although the time remaining for player 1200 is not clearly visible in the figure, time has already elapsed from his clock. Therefore, player 1200 no longer has the same amount of time remaining as does his opponent, even though both started with the same amount of time. Incidentally, the opponent of player 1200 is not visible because, while waiting for player 1200 to arrive, the opponent has gotten up to watch other chess games.

As it happens, player 1200 is left handed, so he wishes for chess clock 1202 to be on his left side during the chess game, rather than on his right side. Therefore, player 1200 picks up the chess clock 1202 and moves it from position 1204 to position 1206 as shown. In moving the chess clock 1202, the player 1200 merely translates the chess clock 1202. The player 1200 does not rotate the chess clock 1202 about any axis. (Of course, the player may rotate the chess clock 1202 by 360 degrees, 720 degrees, etc., just so long as it ends up approximately in its original orientation.) When the chess clock 1202 is put to rest in position 1206, note that display 1208, the display with the player's 1200 time remaining, is still closer to player 1200 than to his opponent's side of the board. However, now it is facing away from player 1200, and cannot be seen by player 1200 when he is sitting at the board. If the chess clock 1202 had been rotated 180 degrees about a vertical axis through its center, display 1208 would now be visible to player 1200. However, display 1208 would now be closer to his opponent's side of the chessboard than to the player's 1200 side, and would therefore unfairly confer the player's 1200 time remaining to the player's opponent. This is why a chess clock of the prior art cannot easily be transferred from one side of a chessboard to the other after the game has commenced, i.e., after time has elapsed from one player's clock. Fortunately, chess clock 1202 of the present invention has displays on both sides of the chess clock. Although not shown, a display appears on the opposite side of the chess clock from display 1208, from where it faces the player in the chess clock's 1202 final position. Furthermore, the display appearing on the opposite side as display 1208 shows the same time remaining as does display 1208. Similarly, display 1210, corresponding to the player's opponent, also has an opposite display (not shown) on the other side of the chess clock 1202, which shows the same time remaining as does display 1210. Therefore, using a chess clock of the present invention, player 1200 has been able to switch the chess clock from one side of the chessboard to the other, without having to reset the times on both clocks. Note also that the procedure of switching the chess clock from one side of the chessboard to the other has not significantly changed the directions from which the players' time remaining may be viewed. Thus, a tournament director who wishes to see the display of a chess clock when standing at a given location would be indifferent as to the side of the chessboard on which the chess clock is located.

Note that chess clock 1202 in FIG. 12 may be alternatively configured so that diagonally opposite displays correspond to the same player. For example, a display on the front and right of the chess clock could correspond to a display facing in the opposite direction on the back and left of the chess clock (rather than on the back and right as described in the previous example). In this case, when the chess clock is moved from one side of the board to the other, the chess clock would have to be rotated 180 degrees about the vertical (or 540 degrees, 900 degrees, etc.) for a display newly facing the players to show the proper time corresponding to the closer of the two players.

In FIG. 12, note that chess clock 1202, in its final position, has two displays facing away from player 1200, off to his right. Suppose that the table in FIG. 12 were longer, and that there was an additional chess game being played to the right of player 1202. Players of such a chess game would be able to view displays 1208 and 1210, and might therefore confuse chess clock 1202 for their own. To avoid such confusion, displays 1208 and 1210 might initially be turned off once chess clock 1202 is put in its final position for the game. The displays may be turned off, for example, using commands provided via input buttons. If the chess game to the right of player 1202 finishes before the game of player 1202, then displays 1208 and 1210 might later be turned on. Again, the displays may be turned on using input buttons. In this way, spectators would now be able to view displays 1208 and 1210, and the displays would no longer confuse any nearby players.

Further Embodiments

Further embodiments of the present invention will now be described. One theme among the following embodiments, and among embodiments already described, is that they allow information relevant to a player at a chess game to be viewed from a wider range of directions than is possible using conventional chess clocks. A typical conventional chess clock has displays that are oriented parallel to, and within a plane, defined by one face of the chess clock. The displays both face outwards from the chess clock. Thus, if the chess clock is regarded as the center of a sphere, information on the displays will be conceivably visible to anyone on half the surface of the sphere, the half that is delineated by the plane of the face of the chess clock in which the displays are situated, and in whose direction the displays are facing. As is well known, half the surface of a sphere defines a solid angle of two pi steradians. That is, the area of half the surface of a sphere is equal to two pi times the radius of the sphere. It is thus one function of the present invention to increase the solid angle over which information about a single player will be visible, to encompass more than two pi steradians. As has been shown, one method of accomplishing this object is for a chess clock to possess multiple displays facing in different directions, each showing information about a player. Now, it may be protested that a chess clock typically rests on a table, and that displays would not be visible from beneath the table, when the surface of the table would interfere with the passage of light. (Thus, with a table obscuring the lower half of a sphere, even a chess clock with multiple displays would allow visibility over at most two pi steradians.) Therefore, one may consider a plane that is parallel to the plane defined by the surface of the table in which the chess clock rests (or equivalently, by the bottom face of the chess clock), and which intersects a display of the chess clock. It may now be noted that, with a conventional chess clock resting on the table, a person in the plane would only be able to view the displays over an angle of 180 degrees (or pi radians) about the chess clock. Thus, one function of the present invention is to allow for at least one hypothetical plane that intersects a display of a chess clock, such that a person located in that plane would be able to view information about a player over more than 180 degrees.

It is also noted that the technology used in some displays may limit the viewing angle of the display. For example, some liquid crystal displays may have limited viewing angles, with preferential viewing occurring when a person looks in a direction perpendicular to the plane of the display. Therefore, a further object of the present invention is to allow for information about a player to be viewed over a wider angle than would be possible using a single display.

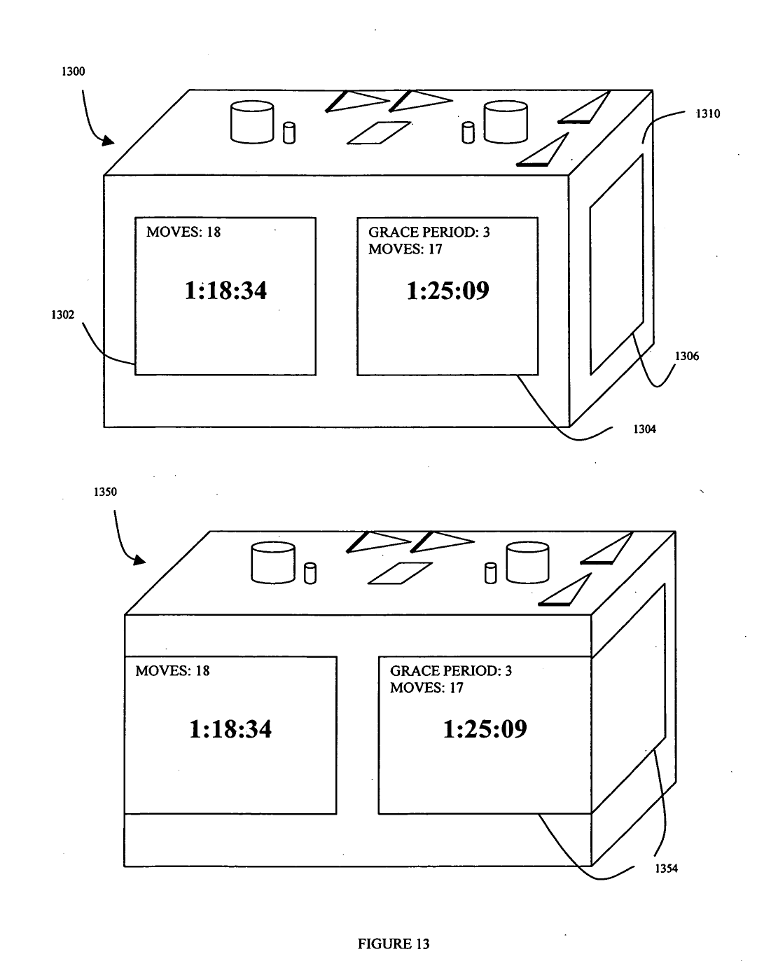

Reference is now made to FIG. 13, which depicts two exemplary chess clocks, 1300 and 1350, of the present invention. Chess clock 1300 has two displays, 1302 and 1304, located on the large front face 1308 of the chess clock. Chess clock 1300 also includes an additional display 1306, located on a side face 1310. Although not shown, a display may also be located on the other side face opposite display 1306. Of course, displays may also be located on the large back face (e.g., side B in FIG. 3). Display 1306 has the benefit of allowing people to view information about players at the chess game even when the people are not able to see the large front 1304 or back faces of the chess clock 1300. For example, a person may be located side-on to the chess clock 1300. Additional displays may be present on the top face, bottom face, or on any other face of the chess clock.

Chess clock 1350 appears similar to chess clock 1300. However, displays 1304 and 1306 of chess clock 1300 have now been joined into a single display 1354 that bends around a corner of the chess clock 1350. Thus, even a single display may allow information to be viewed from more directions than are conventionally possible. The present invention contemplates single displays that are bent, curved, warped, wound around objects, and otherwise acting to display information in an expanded number of directions. One possible technology allowing for the construction of flexible displays is the technology of organic light-emitting diodes. Displays that are bent, curved, warped, or wound around objects may be referred to herein as displays that are “non-planar.”

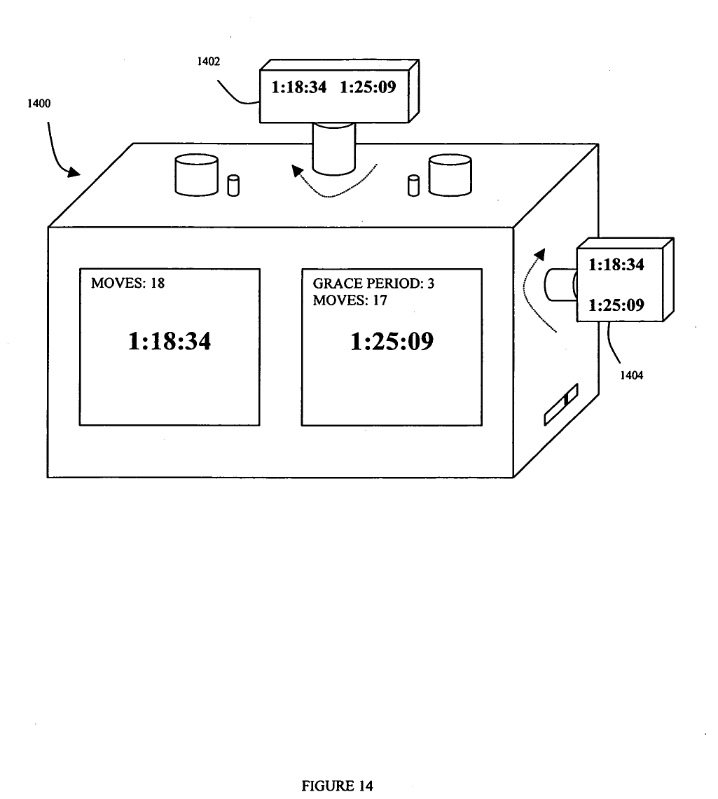

FIG. 14 depicts another exemplary chess clock 1400 of the present invention. In addition to the now familiar features, chess clock 1400 illustrates two mobile displays 1402, and 1404. Displays 1402 and 1404 may be any standard displays, such as LCD displays. Displays 1402 and 1404 are mounted on rotating shafts. In this way the displays can rotate so as to make information visible over a wide viewing range. The shafts may be constructed of conducting material, so that the displays may remain in contact with processor 402 or with display controllers. Displays may also remain in electrical contact with the processor or display controllers via wire brushes. Many other ways are known in the art for maintaining electrical contact between objects in that are in motion relative to one another. The rotation of displays 1402 and 1404 may be powered, for example, by a motor or by a spring and gear assembly. Displays 1402 and 1404 illustrate a further principle contemplated by the present invention. While display 1402, for example, does not allow viewing over more than two pi steradians at any particular instant in time, display 1402 does rotate and thereby allows people situated all around the chess clock 1402 to view information about players at the chess game. Thus, if display 1402 were the only display present on the chess clock 1400, the chess clock 1400 would still be contemplated by the present invention. In one embodiment, it is foreseen that a single display, such as display 1402, would rotate at a reasonable rate so as not to try the patience of spectators not currently able to view it. For example, the display might make a complete rotation every five seconds. Of course, other rotation rates are possible, and the display need not rotate at a continuous angular velocity. Also, a display need not make a complete revolution, but may first make a half revolution, then reverse directions and make a half revolution, then reverse directions again, and so on.

Note that displays 1402 and 1404 rotate about different axes. Display 1402 rotates about a vertical axis and display 1404 rotates about a horizontal axis. One consequence for display 1404 is that information might appear upside down to viewers on one side of the chess clock 1402. Thus, display 1404 may alter the display orientation of displayed information as it proceeds through a revolution. Of course, displays may rotate about many other different axes. A single display may even rotate about multiple axes at different times, or even at the same time. Displays may engage in other types of motion. For example, a display may be hinged, and part of the display may flap back and forth about the hinge. A display may also be mounted on a rod that follows a track carved into a face of the chess clock. For example, a display might follow a track that carries it from the proximity of one clock button to the proximity of the other, and back again. As the rod moves along the track, the rod may rotate, causing the display to rotate as well. The present invention contemplates any other moving display whose motion serves, at least in part, to display information over a wider range of directions than would normally be possible.

It should again be emphasized that the present invention envisions the display of information over a wider than normal range of directions, even when the information is not simultaneously visible over the entire range of directions. One example, as described above, is a mobile display. In another example, a chess clock contains two stationary displays that face in opposite directions. The two displays may show the same information, but may be flashing exactly out of synchrony with one another. Thus, when one display is on, the other is off, and vice versa. Although in this example, no information is displayed over more than two pi steradians at any given instant, the example still falls within the scope of the present invention.

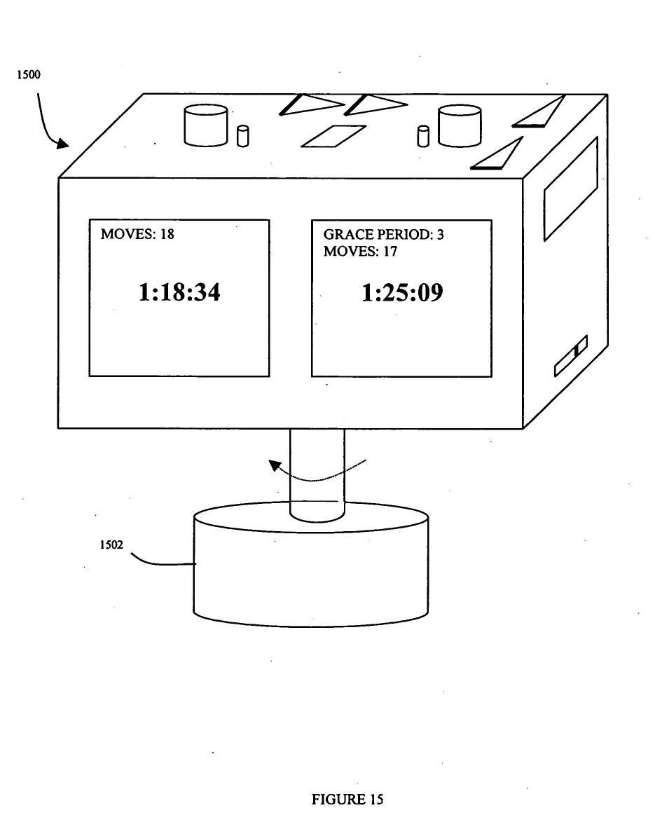

Turning now to FIG. 15, another chess clock 1500 of the present invention is depicted. The chess clock of FIG. 15 is mounted on base 1502, and is operative to rotate around the base. Thus, during the course of rotation, even a solitary display on the front face of the chess clock would become visible over a wider than normal range of directions. As with the mobile displays, the rotation of the chess clock 1500 may be powered by a motor, spring and gear assembly, or by any other means.

In one or more embodiments, the table upon which a chess clock rests rotates about a vertical axis. For example, a chess game may be played upon a rotating stage. In this way, spectators who are not on the stage may periodically view a given display on a chess clock used in the chess game, no matter where they are located with respect to the stage.

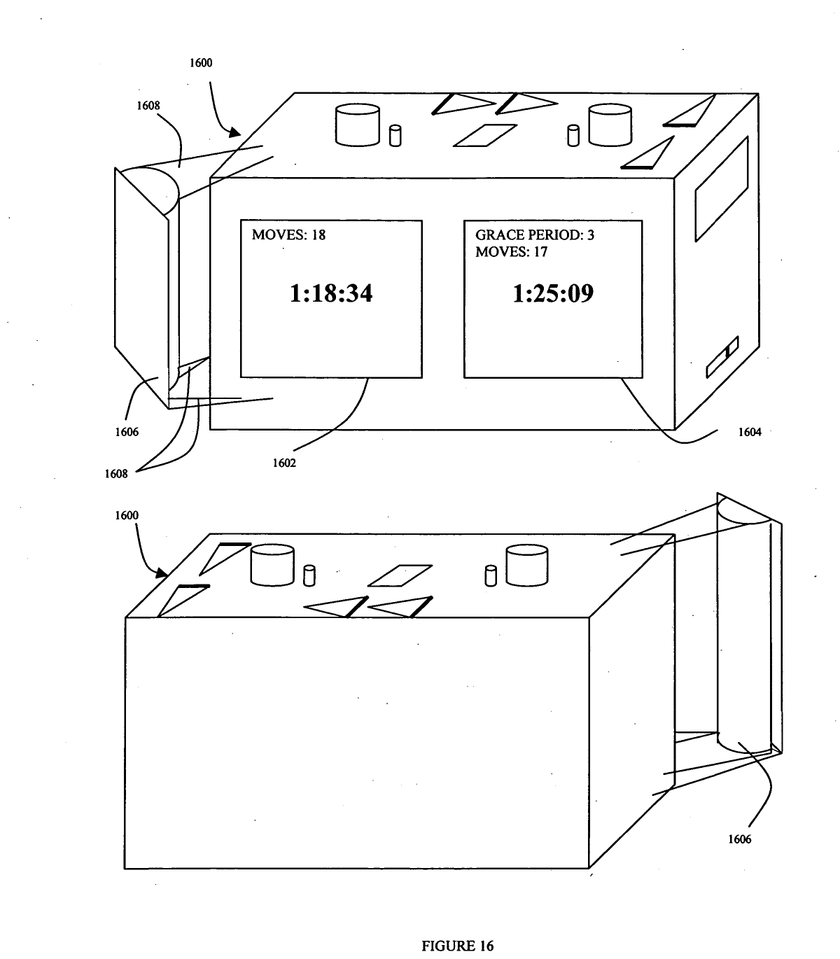

FIG. 16 depicts another chess clock 1600 of the present invention. The chess clock 1600 depicted in FIG. 16 has only two displays, 1602 and 1604. However, chess clock 1600 also comprises a mirror 1606 situated in front and to the side of the displays 1602 and 1604. The mirror 1606 may be attached to the rest of the chess clock via one or more rods 1608. However, many other means of attachment are possible. In one or more embodiments, the mirror may be completely separate from the rest of the chess clock. The mirror 1606 may allow a person located behind the chess clock 1600 (behind the displays) to still view the displays 1602 and 1604 due to their reflections in the mirror 1606. The rear view of chess clock 1600 shows how the mirror 1606 might allow viewing of the displays 1602 and 1604. The mirror 1606 depicted in FIG. 16 is a convex mirror, which has the advantage of allowing viewers to see the displays 1602 and 1604 from a wider range of directions. The mirror 1606 may instead be a flat mirror, which has the advantage of not distorting the image from the displays. The mirror may also be concave, which may be able to invert the image from the displays, so it does not appear backwards when viewed through the mirror. While only one mirror 1606 is shown in FIG. 16, a single chess clock may possess multiple mirrors. For example, chess clock 1600 may contain a second mirror which is positioned at the other side of the chess clock 1600 (near the opposite clock button and the opposite display 1604). In this way both displays would be equally well visible from behind. In other embodiments, mirrors may be situated above the displays, and may thus reflect images back over the top of the chess clock. In some embodiments, a cascade of mirrors is used to reflect an image. For example, two mirrors may be used so that an image does not appear backwards (as it might were only one mirror used). As will be appreciated, many other mirror and display configurations may be used with one object being to increase the range of directions over which information about a player is visible.

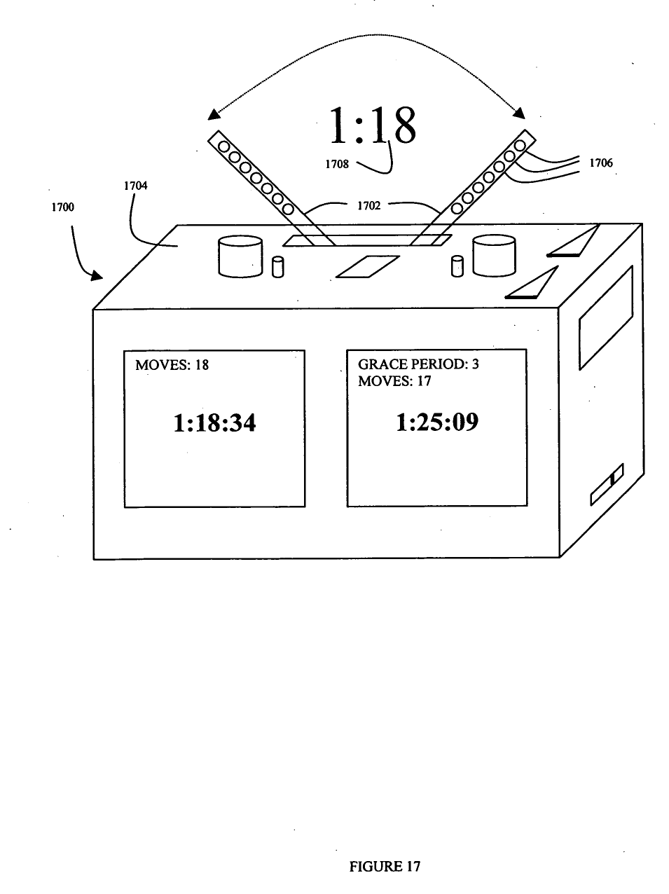

FIG. 17 depicts another chess clock 1700 of the present invention. In the chess clock 1700 of FIG. 17, a bar 1702 projects from the top face 1704 of the chess clock. At its visible end, the bar contains a sequence of light emitting diodes 1706, or other light sources. At its base, the bar is attached to pivot point (not shown). The bar is operable to pivot back and forth about the pivot point very rapidly, as indicated by the arrow in the figure. At the same time, the processor 402, or a display controller for the bar 1702, signals the light emitting diodes 1706 to turn on and off in a specially controlled fashion, coordinated with the motion of the bar 1702. The motion of the bar 1702, together with the carefully controlled switching on and off of the diodes 1706 may then be used to spell out words, numbers, or show any other information. For example, as depicted in FIG. 17, the rapidly moving bar has spelled out “1:18” 1708. Thus, the moving bar 1702 and the diodes 1706 may act as a display. Furthermore, if the diodes 1702 are visible from both the front and back of the chess clock 1700, then the display of information will also be visible from the front and back. So that people on both sides of the chess clock will be able to see displayed information spelled forwards, the bar and diode display may periodically alternate the direction in which information is displayed. For example, from one person's perspective, a time remaining will alternately appear as if it is written forwards, then backwards. Bar and diode displays, as described above, are well known in the art.

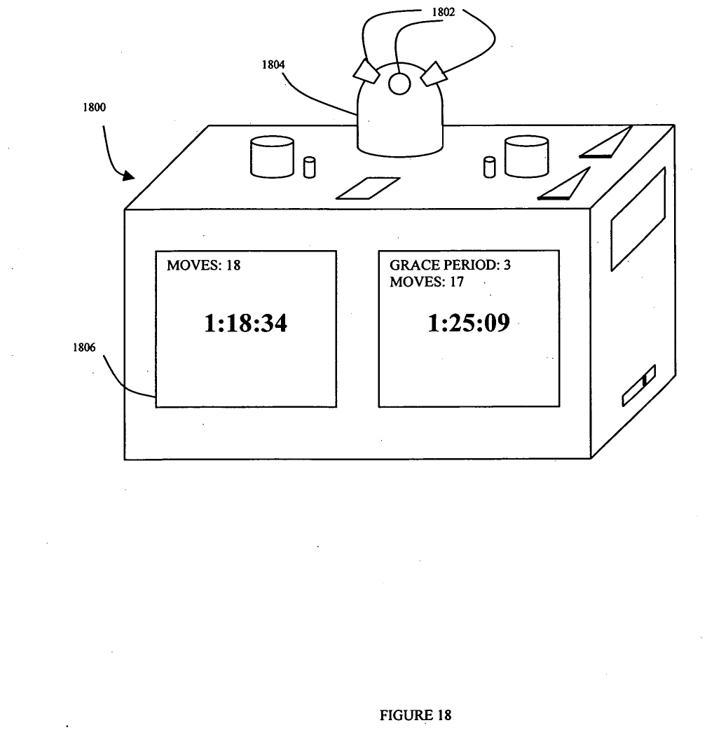

FIG. 18 depicts another chess clock 1800 of the present invention. The chess clock 1800 of FIG. 18 contains several projectors 1802 oriented about a supporting dome 1804. The projectors 1802 may project information about a player onto any convenient surface. For example, the projectors 1802 may project information onto the ceiling, onto the table on which the chess clock 1800, rests, onto a nearby wall, or onto a screen set up for this purpose. Note, for example, that a projection of a time remaining onto the ceiling would allow people from all sides of the chess clock 1800 to look up and see the time remaining. A projection of a time remaining onto a wall would allow every person in a rectangular room to view the projection, since every person in the room would be to one side of the wall. In contrast, people in the room might be located on all sides of a chess clock 1800, and therefore not everyone would be able to see a display such as display 1806. A projection of information onto a table might even aid a player in seeing such information. Often, for example, a player's head is situated high above a chess clock, and the player must alter the position of his head to get a view of a display, which is often located on the side of a chess clock. Therefore, with a projection of information downward onto a table, a player need only look down at the table in order to see the information. Although chess clock 1800 illustrates several projectors, the present invention contemplates a chess clock with one or more projectors.

One or more embodiments of the present invention, although not illustrated in the figures, contemplate a display with a non-opaque back surface. In particular, the back surface may be transparent. For example, a circular clock face may be made of glass, with hour markings etched in black in one side. Therefore, a person viewing the clock face from the back would be able to discern the amount of time remaining, although the clock would appear backwards to him.

In one or more embodiments, one or more displays may not be attached to the main housing of the chess clock. The displays may communicate with the processor of the chess clock via any wireless protocol, such as via infrared, Bluetooth, or Wi-Fi. The processor may thereby direct the displays as to what information to display. Having one or more displays separate from the main body of the chess clock may have a number of advantages. For one, a chess clock may be situated in an area where a view of the whole chess clock is obscured, regardless of the direction in which any of the displays on the chess clock are facing. For example, the chess clock may be situated in front of a pillar. Any person on the opposite side of the pillar would not be able to see the chess clock. Therefore, one of the displays may be placed several feet away from the main body of the chess clock, so that the display covers the area previously behind the pillar. Another advantage of having separate displays is that each player in a chess game may position a display according to his personal viewing preference. If all displays were rigidly connected to the housing of a chess clock, then when one player placed the chess clock according to his viewing preferences, the chess clock would likely not be ideally situated for the other player's viewing preferences. Still another advantage of having separate displays is that a player might be able to carry a display with him, e.g., on a trip to buy food. In this way a player could keep track of his amount of time remaining so that he might avoid taking too long on his trip.

In one or more embodiments, a cell phone, personal digital assistant, pager, laptop, or any other mobile device might be configured to act as a display for a chess clock. For example, a player might configure his personal digital assistant to receive wireless signals from his chess clock indicating his time remaining. Of course, such signals may also indicate any other information, such as a number of moves completed, whose turn it is, and so on. In one or more embodiments a chess clock may be configured to call a cell phone or pager when it has become the next person's turn to move (e.g., the owner's turn to move). The chess clock may contain a transmitter and may store the owner's cell-phone number for calling. The chess clock may receive other phone numbers via input buttons. For example, prior to the start of a game, the player who does not own the chess clock may input his cell phone number, so that he may be called by the chess clock when it is his turn. It is quite common during a chess tournament for a player, when it is not his move, to step away from a chess game and perhaps to carry on a conversation with a friend in another room. It would be useful to such a player to be called on his cell phone when it is his turn to move, so that the player need not periodically interrupt his conversation to go back into the tournament room and check on whether or not it is his move yet. Of course, it is not necessary that mobile devices alone be used as alternate displays. For example, a personal computer or a television set could also maintain communication with a chess clock and display information from the chess clock, or provide alerts concerning, e.g., when it is a new player's turn to move.

It should be noted that there need not be a distinction between a “main body” of a chess clock and a separate display. Rather, a chess clock may consist of multiple disembodied displays together with their individual transmitters, power sources, and processors. Each display may even have its own separate clock button, so that a player may press a clock button at one display, thereby inactivating his own clock, activating his opponent's clock, and effecting the display of information at a distant display. Using such a disembodied chess clock, two players might be able to play a chess game while in different rooms. For example, one player might have special health circumstances requiring him to have his own room with the supervision of a medical professional. Such a player may play a chess game against another player located in a main tournament room. In this example, the chess clock may transmit chess moves back and forth in addition to the signals from clock buttons.

A chess clock may also consist of multiple physically separate components that can be combined into a single unit for a chess game. One advantage of having separate combinable units is that the units may be combined in different ways depending on the directions from which it is desirable that displayed information be visible. For example, suppose two separate blocks, of a similar size and each roughly cube-shaped, make up a chess clock. Each block has a display on one of its six faces. A single display may be used to display, for example, a time remaining for both players. Thus, only a single display need face in a direction from which the players can see it. Therefore, a first of the two blocks may be placed beside the chessboard, with its display face facing towards the chessboard. The second block may then be attached to the first in a number of ways. In one configuration, the second block is attached so that, like the first block, it rests on the table, but has its display facing in the opposite direction from that of the first block. In this case, the blocks may be thought of as being back to back. In another configuration, the second block is stacked on top of the first, also with its display facing in the opposite direction from that of the first display. With the blocks stacked, the display on the second block may be more easily visible. In a third configuration, the second block may be attached to the first so that its display is facing at a right angle to the direction in which the display of the first block is facing. The blocks may attach to each other via interlocking bumps and depressions, as occurs, for example, with Lego® blocks. Furthermore, when blocks are attached, two electrical contact points may come into contact, so that processors or other electrical devices within the respective blocks may communicate when they are attached. Using just the two blocks described herein, it can be appreciated that several different display configurations may be attained, each perhaps suitable to a different situation. It should also be appreciated that each block may have more than a single display, that blocks may take on any number of shapes in addition to the shape of a cube, and that a single chess clock may consist of any number of blocks or other separate components which may later be combined.

In one or more embodiments a display may be attached to the body of a chess clock via a flexible arm. The arm may give way to pressure applied by a human, but may be sufficiently rigid to maintain its shape or configuration when no human pressure is applied. Many desk lamps, for example, have such flexible arms supporting the light source, and allow the light to be directed in a direction desired by the user. In a similar manner, when a flexible arm attaches a display to the body of a chess clock, the display may be raised, lowered, twisted and turned, moved from side to side, and otherwise positioned so as to face in a desired direction. A chess clock may contain multiple displays on multiple different arms, and it will be appreciated that such displays might be made to face in almost any conceivable combination of directions.

In one or more embodiments, a chess clock may emit fireworks e.g., from its top surface. The fireworks may explode into patterns of clock faces or patterns of numerical digits, so that, for example, a time remaining becomes visible to those who witness the explosion. In one or more embodiments, a chess clock may employ one or more holographic displays. Holographic displays may conceivably be viewed from any direction, and therefore accomplish an object of this invention in allowing information about players to be viewed from a wider than normal range of directions.

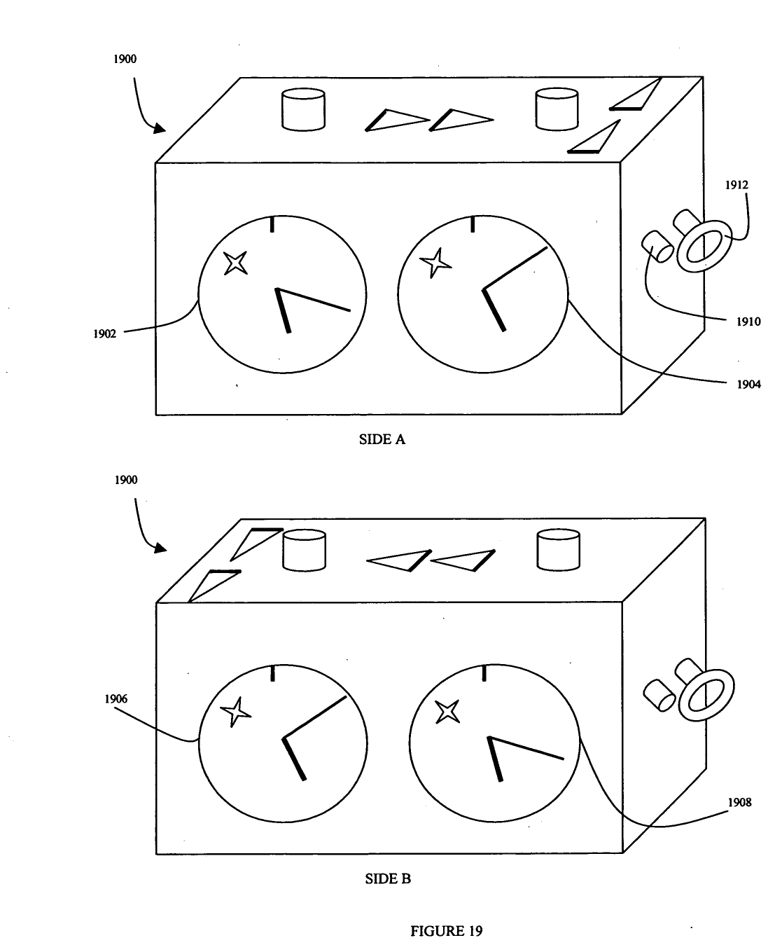

Chess clocks of the present invention have been discussed above mainly with regard to electronically powered chess clocks with digital displays. However, the present invention also contemplates mechanical chess clocks, such as those involving springs, gear assemblies, and circular clock faces with moving hands. FIG. 19 depicts an exemplary chess clock 1900 of the present invention.

FIG. 19 depicts two sides of chess clock 1900, labeled “side A” and “side B”. As can be seen, chess clock 1900 has four displays, two on each of side A (1902 and 1904) and side B (1906 and 1908). In the figure, each display contains physical hands, a physical flag, and a physical ticker (as opposed to electronic displays). In the figure, display 1902 may correspond to display 1908, and display 1904 may correspond to display 1906. That is, corresponding displays may show the same time remaining. With corresponding displays, it is possible that both can be set simultaneously. For example, knob 1910 may be mechanically linked to both displays. 1904 and 1906. Turning knob 1910 may therefore turn the hands of both display 1904 and of display 1906. Similarly, displays 1904 and 1906, may be powered by the same spring, which is mechanically linked to both displays. In this way, both displays 1904 and 1906 may have power so long as one does. Knob 1912 may be used to power the spring when the spring runs out of power. The other two displays, 1902 and 1908, on the chess clock 1900 may similarly be controlled by their own two knobs, one for setting the hand positions, and one for powering the spring. Alternatively, one or more of the four displays may be battery powered. Also, in another embodiment, each of the four displays may be individually controllable in some fashion. One display may, for example, have its own knob for setting a time remaining, and its own spring. Alternatively, a display may share a spring, but may have its own knob for setting a time remaining. In still another variation, a time remaining on a display may only be settable in conjunction with the time remaining on another display. However the display may have its own separate spring. Of course, the chess clock 1900 might just as well have more or fewer displays than the four depicted in FIG. 19.

Even if displays are not electronic, the displays may still be mobile. For example a physical clock face may be mounted on a shaft and may rotate with the shaft. Also, a chess clock with physical displays may be mounted on a platform about which the whole chess clock rotates. A chess clock with physical displays may also possess mirrors to reflect light from the physical displays. Even chess clocks with disembodied displays may possess physical displays.

In one or more embodiments, a chess clock may possess both physical and electronic displays. For example, a chess clock may possess two physical displays on one side, and two electronic displays on an opposite side. By limiting the number of physical displays to two, the mechanical complexity of the chess clock may be limited, while still allowing a player who enjoys mechanical chess clocks to obtain the benefits of the present invention.

In embodiments that include mechanical clocks and/or mechanical clock faces, a time remaining for a player may be said to be stored in a “memory” comprising one or more gears. For example, the configuration of gears in a mechanical clock face may determine the orientation of the hour hand, minute hand, and/or the second hand to which the gears are linked or attached. Thus, a particular gear configuration may correspond to a particular configuration of the hands of the clock, and thus to a particular time remaining.

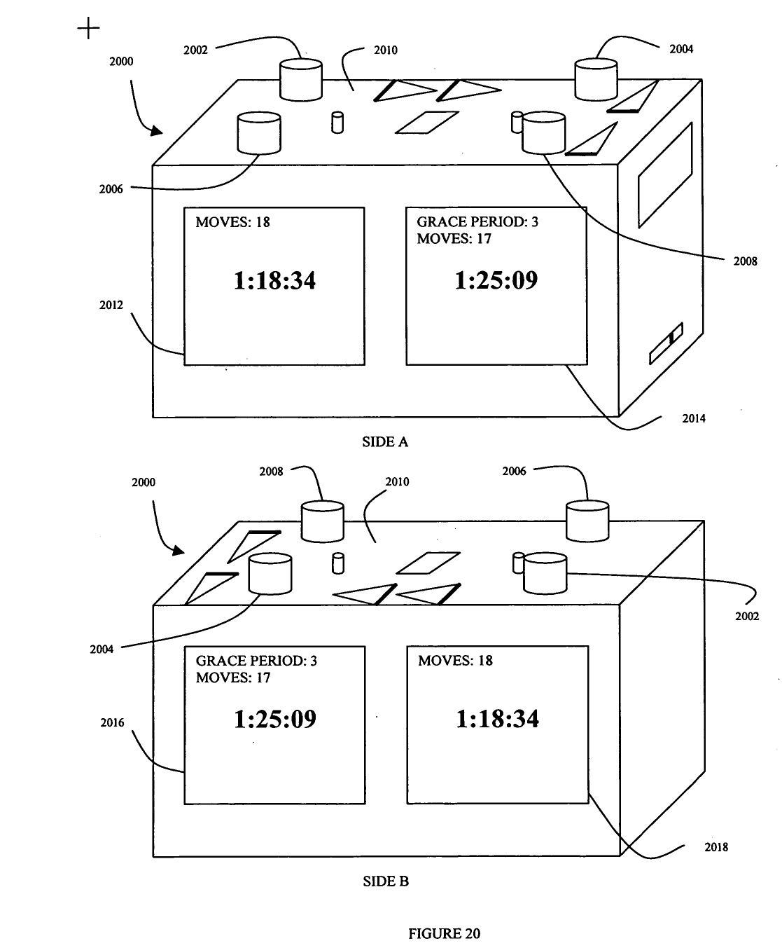

In one or more embodiments, a chess clock of the present invention may have more than two clock buttons. In particular, there may be two clock buttons for each clock. In a chess clock 2000 such as that depicted in FIG. 20, there might be four clock buttons, 2002, 2004, 2006, and 2008, all on the top face 2010 of the chess clock 2000. Each clock button may be located just above a display, so that two of the clock buttons, 2006 and 2008, are located nearer “side A” of the chess clock 2000, and two of the clock buttons, 2002 and 2004, are located nearer the “side B” of the chess clock 2000. At the same time, two of the clock buttons, 2004 and 2008, are located nearer the left of the chess clock 2000, and two, 2002 and 2006, are located nearer the right. In fact, one clock button may be said to lie approximately in each corner of the top face 2010 of the chess clock 2000. In one or more embodiments, groups of clock buttons would have the same function. That is, pressing any clock button from within the group of clock buttons would inactivate a first clock and/or activate a second clock. With a chess clock such as that illustrated in FIG. 20 an advantage of having two clock buttons per clock, for a total of four, can be readily seen. If one group of clock buttons consists of the two clock buttons 2004 and 2008 towards the left of the chess clock 2000, and another group of clock buttons consists of the two clock buttons 2002 and 2006 towards the right of the chess clock 2000, then a player sitting at either the side A or side B of chess clock 2000 would always have a clock button near him. Thus chess clock 2000 may be placed on either side of a chessboard, without change to its orientation, while always maintaining a clock button close to a player at the chess game.

A further advantage of a chess clock with four clock buttons is that the chess clock may be used as two separate chess clocks at the same time. For example, in chess clock 2000 of FIG. 20, the displays 2012 and 2014 on side A may display the times remaining corresponding to a first chess game, while displays 2016 and 2018 of side B may display the times remaining corresponding to a second chess game. The clock button 2006 closest to side A and closest to display 2012 may be used to inactivate the clock whose time is displayed on display 2012, and to simultaneously activate the clock whose time is displayed on display 2014. Similarly, the clock button 2008 closest to side A and closest to display 2014 may be used to inactivate the clock whose time is displayed on display 2014, and to simultaneously activate the clock whose time is displayed on display 2012. Likewise, clock button 2004 may inactivate the clock whose time is displayed on display 2016, and clock button 2002 may inactivate the clock whose time is displayed on display 2018. Where a chess clock of the present invention is used to track times and other information for two or more chess games, the memory may store all relevant times (e.g., four times if the clock is tracking two chess games) and other information. Further, the processor may be operable to receive inputs from each clock button, and to update the stored times accordingly. In other words, the processor may carry out the steps of the flowchart of FIG. 9 for two or more games simultaneously. Additionally, a chess clock of the present invention may contain multiple processors. Each processor may track a separate chess game. Thus, for example, a first processor may receive inputs from a first and second clock button, and a second processor may receive inputs from a third and fourth clock button. Accordingly, the first processor may update times remaining corresponding respectively to the first and second clock buttons, and the second processor may update times remaining corresponding respectively to the third and fourth clock buttons.

A chess clock such as is illustrated in FIG. 20 may be placed between two chessboards, so that the chess clock is to the right of a first chessboard and to the left of a second chessboard. In this way, players at either board would be able to share the chess clock. The chess clock could separately time both games. Although chess clock 2000 demonstrates only two indicator lights, a chess clock usable by four players may contain four indicator lights, one corresponding to each player. Further, one indicator light might be proximate to each clock button, so that each clock button has a corresponding indicator light. A player would know when his clock was activated because the indicator light corresponding to his clock button would be lit.

A further advantage of a chess clock such as that of FIG. 20 is that the chess clock may be readily usable for a game of bughouse, otherwise known as twin chess, Siamese chess, etc. Bughouse is a very popular variant of chess involving four players. Conventionally, bughouse is played with two separate chess clocks, one for each of the two chessboards used in the game. However, a chess clock of the present invention may readily be used to time all four players in a game of bughouse, thereby eliminating the need for an additional chess clock.

A chess clock of the present invention may also display for a first player a time remaining of a second player (e.g., where the second player is the first player's partner in a game of bughouse). Thus, for example, suppose chess clock 2000 were being used for a game of bughouse. Most likely, two players using clock buttons 2002 and 2006 would be partners on a first team, while two players using clock buttons 2004 and 2008 would be partners on a second, opposing team. Accordingly, a first player's time would be displayed for him on display 2012, while the first player's partner's time would be displayed on display 2018. Evidently, the display of the first player's partner would not ordinarily be visible to the first player. Therefore, according to one or more embodiments, the time shown on display 2018 (the first player's partner's time) may also be shown on display 2012, in addition to the first player's time. Thus, the first player would be able to look at display 2012 and see not only his time, but also his partner's time. This is possible because displays 2012 and 2018 are part of a single unit, whereby a time shown on one can be readily communicated to the other. In a conventional game of bughouse in which two clocks are used, a first player may have difficulty ascertaining his partner's time if his partner's clock is facing away from the first player.

It should be appreciated that a chess clock of the present invention that is used to simultaneously track two or more games need not have four clock buttons. Rather, the same clock button might be shared by two or more players. The two or more players might press the button in different ways in order to distinguish themselves from one another. For example, a first player might press the button only once in order to inactivate his clock and to activate his opponent's clock. A second player might press the same button twice in rapid succession in order to inactivate his clock and to activate his opponent's clock. Were the second player to press the clock button only once, he would inadvertently inactivate the clock of the first player, rather than his own clock.

Accordingly, while the present invention has been disclosed in connection with exemplary embodiments thereof, it should be understood that other embodiments may fall within the spirit and scope of the invention as defined by the following claims.

What is claimed is:

1. A device for displaying information about a game comprising:
a body;
a first display operable to display first information about a player of the game; and
a second display operable to display second information about the player of the game, the second display facing in a different direction from that of the first display,
in which the first display and the second display are attached to the body.

2. The device of claim 1 in which first information includes a time remaining for the player.

3. A device for keeping time comprising:
a chassis;
a first memory for storing a first amount of time remaining for a first player of a game, the first memory attached to the chassis;
a first display for displaying the first amount of time, the first display attached to the chassis and coupled to the first memory;
a second display for displaying the first amount of time, the second display attached to the chassis and coupled to the first memory,
in which the second display faces in a different direction from that of the first display;
a second memory storing a second amount of time remaining for a second player of the game, the second memory attached to the chassis;
a third display for displaying the second amount of time, the third display attached to the chassis and coupled to the second memory; and
a fourth display for displaying the second amount of time, the fourth display attached to the chassis and coupled to the second memory.

4. The device of claim 3, in which the second display faces in a direction opposite that of the first display.

5. The device of claim 3, in which the first display and the third display are the same display.

6. The device of claim 3, in which the first display is different from the second display.

7. The device of claim 3, in which the first memory and the second memory are the same memory.

8. The device of claim 3, in which the first memory is a semiconductor memory.

9. The device of claim 3, in which the first memory comprises a gear.

10. The device of claim 3, in which the first display is at least one of:
(a) a liquid crystal display;
(b) a dot matrix display;
(c) a diode display;
(d) a light emitting diode display;
(e) an organic light emitting diode display;
(f) a cathode ray tube;
(e) a projection display;
(f) a mechanical display; and
(g) a mechanical clock face.

11. The device of claim 3 further including:
a signal generator for generating a timing signal, the signal generator coupled to the first memory and to the second memory;
a first button for signaling a first play in the game, the first button attached to the chassis and coupled to the first memory and to the second memory; and
a second button for signaling a second play in the game, the second button attached to the chassis and coupled to the first memory and to the second memory,
in which:
the first memory is operative to reduce the first amount of time remaining upon receipt of signals from the second button;
the first memory is operative to stop reducing the first amount of time remaining upon receipt of signals from the first button;
the second memory is operative to reduce the second amount of time remaining upon the receipt of signals from the first button; and
the second memory is operative to stop reducing the second amount of time remaining upon receipt of signals from the second button.

12. The device of claim 3, further including a processor, the processor attached to the chassis and operative to:
direct the first memory to reduce the first amount of time remaining;
direct the second memory to reduce the second amount of time remaining;
direct the first memory to stop reducing the first amount of time remaining;
direct the second memory to stop reducing the second amount of time remaining;
direct the first display to display the first amount of time; and
direct the second display to display the first amount of time.

13. The device of claim 3, further including a microphone for receiving voice inputs, in which the microphone is electrically coupled to the first memory.

14. A device comprising:
a means for tracking a first time;
a means for tracking a second time;
a first display means for displaying the first time in a first direction;
a second display means for displaying the first time in a second direction; and
an initiation means for initiating the reduction of the first time and halting the reduction of the second time.

15. The device of claim 14 in which the first display means is at least one of:
(a) a liquid crystal display;
(b) a dot matrix display;
(c) a diode display;
(d) a light emitting diode display;
(e) an organic light emitting diode display;
(f) a cathode ray tube;
(e) a projection display;
(f) a mechanical display;
(g) a mechanical clock;
(h) a mirror;
(i) a reflective surface;
(j) a convex mirror;
(k) a concave mirror;
(l) a series of mirrors; and
(m) a transparent panel with opaque indicia.

16. A device comprising:
a body;
a memory, the memory including four memory locations,
in which each of the four memory locations stores a time remaining for a different one of four players; and
four buttons, each of which, when pressed, halts the reduction of a first one of the times remaining stored in a first one of the four memory locations, and initiates the reduction of a second one of the times remaining stored in a second one of the four memory locations,
in which the memory and each of the four buttons are attached to the body.

17. The device of claim 16, further including four displays, in which each display is operable to display one of the times remaining, and in which each display is attached to the body.

18. The device of claim 17, in which a first of the four displays is attached to a first face of the body and a second of the four displays is attached to a second face of the body, in which the first face is different from the second face.

19. The device of claim 16, further including:
a first display operable to display a first and second of the times remaining; and
a second display operable to display a third and fourth of the times remaining,
in which the first display and the second display are attached to the body.
